(19) United States
(12) Patent Application Publication
(10) Pub. No.: US 2025/0265799 A1
(43) Pub. Date: Aug. 21, 2025

(54) LINEAR CAGE DEFORMER FOR MULTI-LAYERED OUTFITS

(71) Applicant: Roblox Corporation, San Mateo, CA (US)

(72) Inventors: Adam Tucker BURR, Suffern, NY (US); Alexander EHRATH, San Marcos, CA (US); Ervin TENG, San Mateo, CA (US); Andrew KUNZ, San Mateo, CA (US)

(73) Assignee: Roblox Corporation, San Mateo, CA (US)

(21) Appl. No.: 19/077,453

(22) Filed: Mar. 12, 2025

Related U.S. Application Data
(63) Continuation-in-part of application No. 18/875,514, filed on Jan. 1, 0001.
(60) Provisional application No. 63/532,621, filed on Aug. 14, 2023.

(51) Int. Cl. G06T 19/20; G06T 17/00

(52) U.S. Cl. CPC G06T 19/20; G06T 17/005; G06T 2210/12; G06T 2210/16; G06T 2219/2016; G06T 2219/2021

(57) ABSTRACT

A linear cage deformer is used to create a deformation of an outer cage of a garment to fit an avatar body of a three-dimensional avatar. The technique may include layering the garment onto the avatar body. The layering may include computing a bulk scale of an overall deformation transformation, constructing influence lists, generating sets of normal vectors, and computing rotation matrices. Then, the layering may further include, for each point in the influence lists, applying corresponding rotation matrices and the bulk scale between points on the inner cage of the garment and the outer cage of the avatar body. Adding these results generates weighted deformed points, which are summed and applied to points on an outer cage of the garment, creating a deformed outer cage for the garment that is usable to fit the garment onto the avatar body.

### CROSS-REFERENCE TO RELATED APPLICATIONS

This application is a continuation-in-part of, and claims priority to, U.S. patent application Ser. No. 18/875,514, filed Dec. 16, 2024, which is a § 371 national stage of PCT International Application No. PCT/US2024/042102, filed Aug. 13, 2024, entitled “LINEAR CAGE DEFORMER FOR MULTI-LAYERED OUTFITS,” which claims priority to U.S. Provisional Application No. 63/532,621, entitled “LINEAR CAGE DEFORMER FOR MULTI-LAYERED OUTFITS,” filed on Aug. 14, 2023, the content of which are incorporated herein in their entirety.

### TECHNICAL FIELD

This disclosure relates generally to computer graphics, and more particularly but not exclusively, relates to methods, systems, and computer readable media to provide graphical representations of multi-layered clothing over an underlying graphical object using a linear cage deformer technique.

### BACKGROUND

Multi-user electronic gaming environments often involve the use of avatars, which represent the players in a virtual experience. Avatars are often three-dimensional (3D) avatars that differ in geometry, shapes, and styles from one avatar to another. For example, avatars may have different body shapes (e.g., tall, short, muscular, thin, male, female, human, animal, alien, etc.), numbers and types of limbs, and are customizable with multiple pieces of clothing/outfits and/or accessories worn by the avatar (e.g., shirt worn over the torso, jacket worn over the shirt, scarf worn over the jacket, hat worn over the head, etc.).

To provide clothing and/or accessories for avatars, game developers traditionally use radial basis functions (RBF) to reshape the garment outer cages. The RBF interpolation and extrapolation are essential for modeling continuous spatial data. However, extrapolation can lead to artifacts that diminish image quality.

When single layer distortions are applied to the garment outer cages on a multi-layer outfit, each layer's new outer cage is computed via the RBF technique for the next outer cage, so single layer distortions compound and get amplified as more layers are added. Hence, the shape of the outfit can be noticeably distorted, and in some cases, the outfit can explode or become enormous.

### SUMMARY

Implementations of the present disclosure relate to techniques of using a linear cage deformer for improved fitting and rendering of multi-layered clothing accessories for three-dimensional (3D) avatars. Such a linear cage deformer may reduce bulkiness that otherwise affects multi-layered clothing and may produce more visually pleasing and realistic looking avatars. The linear cage deformer may be especially effective for rendering an avatar wearing two or more layers of clothing.

For example, the techniques may include providing an avatar in a 3D virtual environment, the avatar having an avatar body to be layered with an inner garment and an outer garment. The inner garment may be layered onto the avatar body, the layering including fitting the inner garment onto the avatar body and deforming an outer cage of the inner garment using a linear cage deformer technique.

Then, the outer garment may be layered onto the inner garment, the layering including fitting the outer garment onto the inner garment and deforming an outer cage of the outer garment using a linear cage deformer technique. After the layering, the avatar body may be rendered with the inner garment and the outer garment layered thereon. The linear cage deformer technique may perform various operations to deform the outer cages of successive garments based on techniques that operate on inner cages of the garments and outer cages of corresponding previous garments.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to provide a three dimensional (3D) avatar with multi-layered clothing in a 3D virtual environment is provided, the computer-implemented method comprising: providing the avatar in the 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the computer-implemented method are described herein.

In some implementations, deforming the outer cage of the inner garment comprises: identifying, for at least one outer cage vertex of the outer cage of the inner garment, a single corresponding vertex on both the outer cage of the avatar body and on the inner cage of the inner garment; generating, using triangles that share the single corresponding vertex, a local coordinate frame of the inner cage of the inner garment and a local coordinate frame of the outer cage of the avatar body; and adjusting a position of the at least one outer cage vertex of the outer cage of the inner garment to deform the outer cage of the inner garment using a difference between the local coordinate frame of the inner cage of the inner garment and the local coordinate frame of the outer cage of the avatar body.

In some implementations, deforming the outer cage of the inner garment causes the outer garment to conform to a shape of the avatar body and a shape of the fitted inner garment.

In some implementations, the outer cage of the inner garment, the inner cage of the outer garment, and the outer cage of the outer garment share a standardized UV layout usable to determine correspondence information between the outer cage of the inner garment and the inner cage of the outer garment, and deforming the outer cage of the outer garment is based on the correspondence information.

In some implementations, the computer-implemented method further comprises: identifying, for at least one outer cage vertex of the outer cage of the outer garment, a single corresponding vertex on both the outer cage of the inner garment and on the inner cage of the outer garment; generating, using triangles that share the single corresponding vertex, a local coordinate frame of the inner cage of the outer garment and a local coordinate frame of the outer cage of the inner garment; and adjusting a position of the at least one outer cage vertex of the outer cage of the outer garment to deform the outer cage of the outer garment using a difference between the local coordinate frame of the inner cage of the outer garment and the local coordinate frame of the outer cage of the inner garment.

In some implementations, adjusting the position of the at least one outer cage vertex of the outer cage of the outer garment preserves an original spacing and alignment between the inner cage of the outer garment and the outer cage of the outer garment while deforming the outer cage of the outer garment.

In some implementations, deforming the outer cage of the inner garment using the linear cage deformer technique comprises: determining a first dataset that describes a volume taken up by the avatar body prior to the fitting the inner garment onto the avatar body and a second dataset that describes a volume taken up by the inner garment after the fitting over the avatar body; calculating differences between corresponding values in the first dataset and in the second dataset; and using sums calculated from the differences and the values in the second dataset to deform the outer cage of the inner garment.

In some implementations, if there are three or more layers of garments, the computer-implemented method further comprises, for each layer: iteratively calculating successive differences in volume between preceding successive garment layers; accumulating the successive differences; and deforming the layer based on the accumulated successive differences.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

In some implementations, iterating over garment cage triangles of the garment and summing vertex offsets and weights of the garment cage triangles comprises: computing difference transforms from previous outer cage (POC) triangles of the previous garment or avatar body portion to corresponding garment inner cage (GIC) triangles of the garment; and transforming vertices of GOC triangles of the garment based on corresponding difference transforms and updating vertex offsets and weights of the GOC triangles of the garment accordingly.

In some implementations, computing difference transforms from the POC triangles of the previous garment or avatar body portion to corresponding GIC triangles comprises computing local three by three matrices for the POC triangles and local three by three matrices for the GIC triangles, and the difference transforms are local difference (LD) three by three matrices calculated by multiplying the POC matrices by inverses of the GIC matrices.

In some implementations, computing the local three by three matrices for POC and GIC triangles comprises, for corresponding triangles of the POC and GIC triangles: finding a first vector and a second vector, where the first vector and the second vector are two triangle edges of the corresponding triangle; finding a third vector that is a cross product of the first vector and the second vector; normalizing the first vector, the second vector, and the third vector; and obtaining the local three by three matrix as a matrix having the first vector, the second vector, and the third vector as basis vectors.

In some implementations, transforming vertices of the GOC triangles based on corresponding difference transforms and updating vertex offsets and weights of the GOC triangles accordingly comprises, for vertices of the GOC triangles: finding original local offset (LO) vectors for the vertices of the GOC triangles by calculating differences of corresponding GOC vertex positions and corresponding GIC vertex positions; transforming the LO vectors by calculating products of local difference (LD) matrices for the corresponding GOC triangles, the original LO vectors, and areas of GIC triangles associated with the corresponding GOC triangles; adding the transformed LO vectors to vertex offsets for the vertices of the GOC triangles; and adding the areas of the GIC triangles to vertex weights for the vertices of the GOC triangles.

In some implementations, deforming the outer cage of the garment based on a deformed garment outer cage (GOC) position determined from iterating over the vertices of the outer cage of the garment comprises: finding, for vertices of the outer cage of the garment, final local offsets as previously summed vertex offsets divided by previously summed vertex weights; and deforming the outer cage of the garment based on the deformed GOC position of the outer cage of the garment determined based on vertices obtained as previous outer cage (POC) positions summed with the final local offsets.

According to another aspect, a non-transitory computer-readable medium is provided. The non-transitory computer-readable medium has instructions stored thereon that, responsive to execution by a processing device, causes the processing device to perform operations comprising: providing an avatar in a 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the non-transitory computer-readable medium are described herein.

In some implementations, deforming the outer cage of the inner garment causes the outer garment to conform to a shape of the avatar body and a shape of the fitted inner garment.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

According to another aspect, a system is disclosed, comprising: a memory with instructions stored thereon; and a processing device, coupled to the memory, the processing device configured to access the memory, wherein the instructions when executed by the processing device cause the processing device to perform operations comprising: providing an avatar in a 3D virtual environment, the avatar having an avatar body to be layered with an inner garment and an outer garment; layering the inner garment onto the avatar body, wherein the layering includes: fitting the inner garment onto the avatar body; and deforming, using a linear cage deformer technique, an outer cage of the inner garment based on one or more of an outer cage of the avatar body and an inner cage of the inner garment; layering the outer garment onto the inner garment, wherein the layering includes: fitting the outer garment onto the inner garment based on the deformed outer cage of the inner garment and an inner cage of the outer garment; and deforming, using the linear cage deformer technique, an outer cage of the outer garment based on one or more of the deformed outer cage of the inner garment and the inner cage of the outer garment; and rendering the avatar body with the inner garment and the outer garment layered thereon.

Various implementations of the system are described herein.

In some implementations, deforming the outer cage of the inner garment causes the outer garment to conform to a shape of the avatar body and a shape of the fitted inner garment.

In some implementations, the linear cage deformer technique comprises, to deform an outer cage of a garment based on an outer cage of a previous garment or avatar body portion: iterating over garment cage triangles of the garment and summing vertex offsets and weights of the garment cage triangles; and deforming the outer cage of the garment based on a deformed garment outer cage (GOC) position determined from iterating over vertices of the outer cage of the garment.

According to one aspect, a computer-implemented method to create a deformation of an outer cage of a garment to fit an avatar body of a three-dimensional (3D) avatar is provided, the method comprising: layering the garment onto the avatar body, wherein an inner cage of the garment defines a source cage, an outer cage of the garment defines a source outer cage, and an outer cage of the avatar body defines a destination cage, wherein the layering includes: computing a bulk scale of an overall deformation transformation using a bounding box of the outer cage of the garment and a bounding box of the outer cage of the avatar body; constructing influence lists for points on the source outer cage, wherein the influence lists define points on the source cage and points on the destination cage influenced by the points on the source outer cage; generating first normal vectors for faces on the source cage adjacent to corresponding points and second normal vectors for faces on the destination cage adjacent to corresponding points; computing rotation matrices for the points on the source cage and corresponding points on the destination cage using the first and second normal vectors; for each point in the influence lists, applying corresponding rotation matrices and the bulk scale of the overall deformation transformation to offset vectors between the points on the source inner cage and the corresponding points on the source outer cage; adding results of the applying to corresponding points on the destination cage to generate weighted deformed points; and for points on the source outer cage, finding coordinates associated with a sum of the weighted deformed points and assigning the coordinates to the corresponding points in the source outer cage to create the deformation of the outer cage of the garment, wherein the deformation of the outer cage of the garment is usable to fit the garment onto the avatar body.

Various implementations of the computer-implemented method are described herein.

In some implementations, constructing influence lists for the points on the source outer cage comprises: creating a k-dimensional tree (K-D tree) of points on the source outer cage; and for points on the source cage and for points on the destination cage: defining a center point as a current point on the source cage or the destination cage; searching the K-D tree for nearby points on the source outer cage within a radius of the center point proportional to a thickness of the garment; and computing weights for points on the source outer cage within the radius of the center point; and sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

In some implementations, the computer-implemented method further comprises computing the thickness of the garment as a length of a vector from the center point to a corresponding point on the source outer cage.

In some implementations, the computer-implemented method further comprises normalizing the computed weights for the points.

In some implementations, computing rotation matrices for points on the source cage and corresponding points on the destination cage comprises: computing initial matrices using outer products of the vectors for the points on the source cage and the corresponding vectors for the points on the destination cage; computing singular value decompositions (SVDs) of the initial matrices to generate U matrices and transposed V matrices; and computing the rotation matrices using the U matrices and the transposed V matrices, wherein the rotation matrices transform points in a garment coordinate system to corresponding points in an avatar coordinate system.

In some implementations, applying, for each point in the influence lists, comprises: for points on the source outer cage: defining a center point as a point of the source outer cage being iterated on; for points on the source cage that are influenced by the center point: obtaining the corresponding point on the source outer cage; computing an offset vector between the source cage at the point influenced by the center point and the source outer cage at the corresponding point; applying the corresponding rotation and the bulk scale to the offset vector to produce a new vector; obtaining a weighted deformed point based on the new vector and a corresponding weight from the influence lists; and adding the weighted deformed point to a corresponding vertex map; and totaling the weighted deformed points in the vertex map to produce the sum of the weighted deformed points.

In some implementations, the computer-implemented method further comprises upsampling the outer cage of the garment after creating the deformation of the outer cage of the garment.

In some implementations, the computer-implemented method further comprises subdividing the outer cage of the garment.

In some implementations, the computer-implemented method further comprises using interpolation on the subdivided outer cage of the garment to produce a higher-quality fit for multiple clothing layers.

According to one aspect, a non-transitory computer-readable medium is provided. The non-transitory computer-readable medium has instructions stored thereon that, responsive to execution by a processing device, causes the processing device to perform operations comprising: layering a garment onto an avatar body of a three-dimensional avatar, wherein an inner cage of the garment defines a source cage, an outer cage of the garment defines a source outer cage, and an outer cage of the avatar body defines a destination cage, wherein the layering includes: computing a bulk scale of an overall deformation transformation using a bounding box of the outer cage of the garment and a bounding box of the outer cage of the avatar body; constructing influence lists for points on the source outer cage, wherein the influence lists define points on the source cage and points on the destination cage influenced by the points on the source outer cage; generating first normal vectors for faces on the source cage adjacent to corresponding points and second normal vectors for faces on the destination cage adjacent to corresponding points; computing rotation matrices for the points on the source cage and corresponding points on the destination cage using the first and second normal vectors; for each point in the influence lists, applying corresponding rotation matrices and the bulk scale of the overall deformation transformation to offset vectors between the points on the source cage and the corresponding points on the source outer cage; adding results of the applying to corresponding points on the destination cage to generate weighted deformed points; and for points on the source outer cage, finding coordinates associated with a sum of the weighted deformed points and assigning the coordinates to the corresponding points in the source outer cage to create a deformation of the outer cage of the garment, wherein the deformation of the outer cage of the garment is usable to fit the garment onto the avatar body.

Various implementations of the non-transitory computer-readable medium are described herein.

In some implementations, constructing influence lists for the points on the source outer cage comprises: creating a k-dimensional tree (K-D tree) of points on the source outer cage; and for points on the source cage and for points on the destination cage: defining a center point as a current point on the source cage or the destination cage; searching the K-D tree for nearby points on the source outer cage within a radius of the center point proportional to a thickness of the garment; and computing weights for points on the source outer cage within the radius of the center point; and sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

In some implementations, the operations further comprise computing the thickness of the garment as a length of a vector from the center point to a corresponding point on the source outer cage.

In some implementations, the operations further comprise normalizing the computed weights for the points.

In some implementations, computing rotation matrices for points on the source cage and corresponding points on the destination cage comprises: computing initial matrices using outer products of the vectors for the points on the source cage and the corresponding vectors for the points on the destination cage; computing singular value decompositions (SVDs) of the initial matrices to generate U matrices and transposed V matrices; and computing the rotation matrices using the U matrices and the transposed V matrices, wherein the rotation matrices transform points in a garment coordinate system to corresponding points in an avatar coordinate system.

In some implementations, applying, for each point in the influence lists, comprises: for points on the source outer cage: defining a center point as a point of the source outer cage being iterated on; for points on the source cage that are influenced by the center point: obtaining the corresponding point on the source outer cage; computing an offset vector between the source cage at the point influenced by the center point and the source outer cage at the corresponding point; applying the corresponding rotation and the bulk scale to the offset vector to produce a new vector; obtaining a weighted deformed point based on the new vector and a corresponding weight from the influence lists; and adding the weighted deformed point to a corresponding vertex map; and totaling the weighted deformed points in the vertex map to produce the sum of the weighted deformed points.

According to one aspect, a system is disclosed, comprising: a memory with instructions stored thereon; and a processing device, coupled to the memory, the processing device configured to access the memory, wherein the instructions when executed by the processing device cause the processing device to perform operations comprising: layering a garment onto an avatar body of a three-dimensional (3D) avatar, wherein an inner cage of the garment defines a source cage, an outer cage of the garment defines a source outer cage, and an outer cage of the avatar body defines a destination cage, wherein the layering includes: computing a bulk scale of an overall deformation transformation using a bounding box of the outer cage of the garment and a bounding box of the outer cage of the avatar body; constructing influence lists for points on the source outer cage, wherein the influence lists define points on the source cage and points on the destination cage influenced by the points on the source outer cage; generating first normal vectors for faces on the source cage adjacent to corresponding points and second normal vectors for faces on the destination cage adjacent to corresponding points; computing rotation matrices for the points on the source cage and corresponding points on the destination cage using the first and second normal vectors; for each point in the influence lists, applying corresponding rotation matrices and the bulk scale of the overall deformation transformation to offset vectors between the points on the source cage and the corresponding points on the source outer cage; adding results of the applying to corresponding points on the destination cage to generate weighted deformed points; and for points on the source outer cage, finding coordinates associated with a sum of the weighted deformed points and assigning the coordinates to the corresponding points in the source outer cage to create a deformation of the outer cage of the garment, wherein the deformation of the outer cage of the garment is usable to fit the garment onto the avatar body.

Various implementations of the system are described herein.

In some implementations, constructing influence lists for the points on the source outer cage comprises: creating a k-dimensional tree (K-D tree) of points on the source outer cage; and for points on the source cage and for points on the destination cage: defining a center point as a current point on the source cage or the destination cage; searching the K-D tree for nearby points on the source outer cage within a radius of the center point proportional to a thickness of the garment; and computing weights for points on the source outer cage within the radius of the center point; and sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

In some implementations, the operations further comprise computing the thickness of the garment as a length of a vector from the center point to a corresponding point on the source outer cage.

In some implementations, computing rotation matrices for points on the source cage and corresponding points on the destination cage comprises: computing initial matrices using outer products of the vectors for the points on the source cage and the corresponding vectors for the points on the destination cage; computing singular value decompositions (SVDs) of the initial matrices to generate U matrices and transposed V matrices; and computing the rotation matrices using the U matrices and the transposed V matrices, wherein the rotation matrices transform points in a garment coordinate system to corresponding points in an avatar coordinate system.

In some implementations, applying, for each point in the influence lists, comprises: for points on the source outer cage: defining a center point as a point of the source outer cage being iterated on; for points on the source cage that are influenced by the center point: obtaining the corresponding point on the source outer cage; computing an offset vector between the source cage at the point influenced by the center point and the source outer cage at the corresponding point; applying the corresponding rotation and the bulk scale to the offset vector to produce a new vector; obtaining a weighted deformed point based on the new vector and a corresponding weight from the influence lists; and adding the weighted deformed point to a corresponding vertex map; and totaling the weighted deformed points in the vertex map to produce the sum of the weighted deformed points.

According to one aspect, a computer-implemented method to provide a three-dimensional (3D) avatar with multi-layered clothing is provided, the method comprising: generating an estimated outer cage by layering a plurality of garments onto an avatar body of the 3D avatar in a specific order, wherein each garment has a respective rigidity, inner cage, and outer cage, and wherein the plurality of garments together form an outfit, wherein the outfit is associated with an outer layer weight; generating a target outer cage by layering the plurality of garments onto the avatar body in the specific order with compression, wherein the layering with compression comprises adding a first outer garment over an inner garment previously layered onto the avatar body, the first outer garment being layered based on the rigidity of the first outer garment and the outer layer weight of the outfit; and applying compression to the estimated outer cage based on using the target outer cage as a compression target to generate a final outer cage.

Various implementations of the computer-implemented method are described herein.

In some implementations, layering the plurality of garments onto the avatar with compression further comprises, after adding the first outer garment over the inner garment, layering a second outer garment over the first outer garment based on the rigidity of the second outer garment and the outer layer weight of the outfit.

In some implementations, the computer-implemented method further comprises determining tailored inner cages and tailored outer cages of individual garments in the plurality of garments based on applying the corresponding garments directly to the avatar body.

In some implementations, layering the plurality of garments onto the avatar with compression further comprises: determining a weighted inner cage based on a weighted average of the tailored inner cage of the first outer garment and the tailored outer cage of the inner garment; and fitting the first outer garment to the weighted inner cage.

In some implementations, the weighted average is calculated based on the outer layer weight.

In some implementations, in response to the rigidity of the first outer garment being greater than a first threshold value and the rigidity of the inner garment being less than a second threshold value, layering the plurality of garments onto the avatar with compression causes the inner garment to not be visible.

In some implementations, in response to the rigidity of the first outer garment being less than a first threshold value and the rigidity of the inner garment being greater than a second threshold value, layering the plurality of garments onto the avatar with compression fits the outer garment to the inner garment as if the inner garment were an avatar body.

According to one aspect, a non-transitory computer-readable medium is provided. The non-transitory computer-readable medium has instructions stored thereon that, responsive to execution by a processing device, causes the processing device to perform operations comprising: generating an estimated outer cage by layering a plurality of garments onto an avatar body of a three-dimensional (3D) avatar in a specific order, wherein each garment has a respective rigidity, inner cage, and outer cage, and wherein the plurality of garments together form an outfit, wherein the outfit is associated with an outer layer weight; generating a target outer cage by layering the plurality of garments onto the avatar body in the specific order with compression, wherein the layering with compression comprises adding a first outer garment over an inner garment previously layered onto the avatar body, the first outer garment being layered based on the rigidity of the first outer garment and the outer layer weight of the outfit; and applying compression to the estimated outer cage based on using the target outer cage as a compression target to generate a final outer cage.

Various implementations of the non-transitory computer-readable medium are described herein.

In some implementations, layering the plurality of garments onto the avatar with compression further comprises, after adding the first outer garment over the inner garment, layering a second outer garment over the first outer garment based on the rigidity of the second outer garment and the outer layer weight of the outfit.

In some implementations, the operations further comprise determining tailored inner cages and tailored outer cages of individual garments in the plurality of garments based on applying the corresponding garments directly to the avatar body.

In some implementations, layering the plurality of garments onto the avatar with compression further comprises: determining a weighted inner cage based on a weighted average of the tailored inner cage of the first outer garment and the tailored outer cage of the inner garment; and fitting the first outer garment to the weighted inner cage.

In some implementations, the weighted average is calculated based on the outer layer weight.

In some implementations, in response to the rigidity of the first outer garment being greater than a first threshold value and the rigidity of the inner garment being less than a second threshold value, layering the plurality of garments onto the avatar with compression causes the inner garment to not be visible.

In some implementations, in response to the rigidity of the first outer garment being less than a first threshold value and the rigidity of the inner garment being greater than a second threshold value, layering the plurality of garments onto the avatar with compression fits the outer garment to the inner garment as if the inner garment were an avatar body.

According to one aspect, a system is disclosed, comprising: a memory with instructions stored thereon; and a processing device, coupled to the memory, the processing device configured to access the memory, wherein the instructions when executed by the processing device cause the processing device to perform operations comprising: generating an estimated outer cage by layering a plurality of garments onto an avatar body of a three-dimensional (3D) avatar in a specific order, wherein each garment has a respective rigidity, inner cage, and outer cage, and wherein the plurality of garments together form an outfit, wherein the outfit is associated with an outer layer weight; generating a target outer cage by layering the plurality of garments onto the avatar body in the specific order with compression, wherein the layering with compression comprises adding a first outer garment over an inner garment previously layered onto the avatar body, the first outer garment being layered based on the rigidity of the first outer garment and the outer layer weight of the outfit; and applying compression to the estimated outer cage based on using the target outer cage as a compression target to generate a final outer cage.

Various implementations of the system are described herein.

In some implementations, layering the plurality of garments onto the avatar with compression further comprises, after adding the first outer garment over the inner garment, layering a second outer garment over the first outer garment based on the rigidity of the second outer garment and the outer layer weight of the outfit.

In some implementations, the operations further comprise determining tailored inner cages and tailored outer cages of individual garments in the plurality of garments based on applying the corresponding garments directly to the avatar body.

In some implementations, layering the plurality of garments onto the avatar with compression further comprises: determining a weighted inner cage based on a weighted average of the tailored inner cage of the first outer garment and the tailored outer cage of the inner garment; and fitting the first outer garment to the weighted inner cage.

In some implementations, the weighted average is calculated based on the outer layer weight.

In some implementations, in response to the rigidity of the first outer garment being greater than a first threshold value and the rigidity of the inner garment being less than a second threshold value, layering the plurality of garments onto the avatar with compression causes the inner garment to not be visible.

In some implementations, in response to the rigidity of the first outer garment being less than a first threshold value and the rigidity of the inner garment being greater than a second threshold value, layering the plurality of garments onto the avatar with compression fits the outer garment to the inner garment as if the inner garment were an avatar body.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram illustrating an example implementation of a linear cage deformer, in accordance with some implementations.

FIG. 2 is a diagram illustrating an example of an avatar with multiple layers of clothing, in accordance with some implementations.

FIG. 3 is a diagram illustrating an example of an avatar with multiple layers of clothing, in accordance with some implementations.

FIG. 4 is a diagram illustrating an example of an avatar with multiple layers of clothing, in accordance with some implementations.

FIG. 5A is a diagram illustrating an example of an avatar without clothing and with multiple layers of clothing, comparing existing radial basis function (RBF) techniques to techniques using linear cage deformer techniques, in accordance with some implementations.

FIG. 5B is another diagram illustrating an example of an avatar without clothing and with multiple layers of clothing, comparing existing radial basis function (RBF) techniques to techniques using linear cage deformer techniques, in accordance with some implementations.

FIG. 5C is another diagram illustrating an example of an avatar without clothing and with multiple layers of clothing, comparing existing radial basis function (RBF) techniques to techniques using linear cage deformer techniques, in accordance with some implementations.

FIG. 6 illustrates a flowchart of an example computer-implemented method to provide a three-dimensional (3D) avatar with multi-layered clothing in a 3D virtual environment, in accordance with some implementations.

FIG. 7 illustrates a flowchart of an example computer-implemented method to adjust a position of an outer cage vertex of an outer cage of an inner garment, in accordance with some implementations.

FIG. 8 illustrates a flowchart of an example computer-implemented method to adjust a position of an outer cage vertex of an outer cage of an outer garment, in accordance with some implementations.

FIG. 9 illustrates a flowchart of an example computer-implemented method to deform an outer cage of an inner garment, in accordance with some implementations.

FIG. 10 illustrates a flowchart of an example computer-implemented method to deform an outer cage of a garment, in accordance with some implementations.

FIG. 11 illustrates a flowchart of an example computer-implemented method to update vertex offsets and weights of garment outer cage (GOC) triangles, in accordance with some implementations.

FIG. 12 illustrates a flowchart of an example computer-implemented method to find difference transforms, in accordance with some implementations.

FIG. 13 illustrates a flowchart of an example computer-implemented method to obtain local matrices from vectors, in accordance with some implementations.

FIG. 14 illustrates a flowchart of an example computer-implemented method to update vertex offsets and vertex weights, in accordance with some implementations.

FIG. 15 is a diagram of an example system architecture that includes a 3D environment platform that can support 3D avatars with multi-layered clothing, in accordance with some implementations.

FIG. 16 is a block diagram that illustrates an example computing device which may be used to implement one or more features described herein, in accordance with some implementations.

FIG. 17 illustrates examples of cages under a linear deformer which experience crossover and spikes.

FIG. 18 illustrates a garment with an outer cage and geometry and a corresponding outer cage with crossover and a linear deformer outer cage.

FIG. 19 illustrates a garment with an outer cage and geometry and a corresponding geometry with crossover and a linear deformer geometry.

FIG. 20 illustrates a flowchart of an example computer-implemented method to provide a three-dimensional (3D) avatar and layer a garment onto an associated avatar body, in accordance with some implementations.

FIG. 21 illustrates a flowchart of an example computer-implemented method to layer a garment onto an avatar body, in accordance with some implementations.

FIG. 22 illustrates a flowchart of an example computer-implemented method to construct influence lists, in accordance with some implementations.

FIG. 23 illustrates a flowchart of an example computer-implemented method to compute rotation matrices, in accordance with some implementations.

FIG. 24 illustrates a flowchart of an example computer-implemented method to process points in an influence list, in accordance with some implementations.

FIG. 25 illustrates avatars with layered clothing having an inner layer associated with various levels of rigidity, in accordance with some implementations.

FIG. 26 illustrates three example garments, each including an inner cage and an outer cage, each associated with a rigidity value, in accordance with some implementations.

FIG. 27 illustrates two passes in which garments are layered on top of one another, in accordance with some implementations.

FIG. 28 illustrates a flowchart of an example computer-implemented method to layer garments onto an avatar body, in accordance with some implementations.

FIG. 29 illustrates a flowchart of an example computer-implemented method to layer an outer garment onto an inner garment, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques of a linear cage deformer for improved fitting and rendering of multi-layered clothing accessories for three-dimensional (3D) avatars. The linear cage deformer reduces bulkiness of multi-layered clothing and generates more visually pleasing and realistic-looking dressed avatars. The deformer affects visuals of the avatar wearing two or more layers of clothing and retains the same appearances as when wearing single-layer clothing setups.

Existing layered clothing techniques use cage meshes to reshape garments to fit on arbitrarily shaped avatars. Such a layered clothing may apply layers of clothing using a radial basis function (RBF). The layered clothing system also supports multi-layered outfits. However, using RBF functions for multi-layered clothing presents problems. RBF uses interpolation and extrapolation, which may introduce distortions that lower image quality. Such distortions may be minor for a single layer of clothing, but as successive layers are fitted, using the RBF technique amplifies the distortions and causes substantial problems in rendering an avatar with multiple layers of clothing.

An avatar with multiple layers of clothing may have all of the cages (both inner and outer) for the multiple layers of clothing share a standardized UV layout. Accordingly, RBF may not be used to reshape garment outer cages. Instead, linear cage deformer techniques may find corresponding vertices of a garment inner cage and the previous layer outer cage (where the previous layer is an avatar body or the last garment fitted). Triangles that share these corresponding vertices may be used to find local coordinate frames for both cages. The position of the outer cage vertex of the current garment (i.e., the garment in a process of being layered) may then be adjusted and/or transformed using a difference between these new coordinate frames.

Adjusting vertices in outer cages of successive garments as set forth herein may have several potentially valuable properties. The provided techniques preserve the original spacing and alignment between the garment inner and outer cage for each garment when the new (i.e., adjusted) outer cage is generated. This improves the quality of the new outer cage. Additionally, because no extrapolation error is introduced, the artifacts are reduced as more layers are added.

The techniques permit any body geometry to be fitted with any clothing geometry, including enabling layers of clothing to be fitted over underlying layer(s) of clothing, thereby providing customization without the limits imposed by pre-defined geometries or using complex computations to make a clothing item compatible with arbitrary body shapes of avatars or other clothing items.

The multi-layered clothing fitting is also performed using a technique (i.e., algorithmically) such as a linear cage deformer technique by a gaming platform or gaming software (or other platform/software that operates to provide a 3D environment), without having avatar creators (avatar body creators, or body creators) or clothing item creators perform complex computations. The terms “clothing,” “clothing item,” or “clothing accessory” used herein are understood to include clothing and accessories, and any other item that can be placed on an avatar in relation to specific parts of an avatar body.

A linear cage deformer technique describes a space to apply to a clothing accessory or clothing item on an avatar when the multiple clothing items or accessories are layered on top of each other. For example, the techniques may be utilized to determine a first dataset that describes volume taken up by an unclothed body part of an avatar (e.g., a torso) and a second dataset that describes a volume taken up by a clothing item (e.g., a shirt) layered over the unclothed body part of the avatar.

The difference is computed between the first and the second datasets. The difference is then added to the second dataset when a subsequent layer of clothing is to be added on top of the first layer of clothing. When dealing with multi-layered clothing, the techniques iteratively apply a procedure involving calculating the differences between successive clothing layers and then accumulate these differences to create the final layered effect.

The techniques described herein for multi-layered clothing may be applied to avatars that are used in a virtual experience. Such virtual experiences are sometimes described herein in the context of an electronic game. The techniques described herein can be used for other types of virtual experiences in a three-dimensional (3D) environment that may not necessarily involve an electronic game having one or more players represented by avatars. Examples of virtual experiences may include a virtual reality (VR) conference, a 3D session (e.g., an online lecture or other type of presentation involving 3D avatars), an augmented reality (AR) session, or in other types of 3D environments in which one or more users are represented in the 3D environment by one or more 3D avatars.

For layered clothing, an automated cage-to-cage fitting technique may be used for 3D avatars. The techniques permit any body geometry to be fitted with any clothing geometry, including enabling layers of clothing to be fitted over underlying layer(s) of clothing, thereby providing customization without the limits imposed by pre-defined geometries, or using complex computations to make a clothing item compatible with arbitrary body shapes of avatars or other clothing items.

The cage-to-cage fitting techniques can also be performed on a gaming platform or gaming software (or other virtual experience platform/software that operates to provide a 3D environment) without having avatar creators (also referred to as avatar body creators, or body creators) or clothing item creators perform complex computations. The terms “clothing” or “piece of clothing” or other analogous terminology used herein are understood to include graphical representations of clothing and accessories, and any other item that can be placed on an avatar in relation to specific parts of an avatar cage.

At runtime during a virtual experience session, a player/user accesses a body library to select a particular avatar body and accesses a clothing library to select pieces of clothing to place on the selected body. A 3D environment platform that presents avatars implements the cage-to-cage fitting techniques to adjust (by suitable deformations, determined automatically) a piece of clothing to conform to the shape of the body, thereby automatically fitting the piece of clothing onto the avatar body (and any intermediate layers, if worn by the avatar).

When the piece of clothing is fitted over the avatar body and/or underlying piece of clothing on the avatar body, the techniques described herein may be performed to deform or otherwise fit the piece of clothing more precisely to the avatar, such as in terms of scale (e.g., proportionality), shape, etc. The user can further select an additional piece of clothing to fit over an underlying piece of clothing, with the additional piece of clothing being deformed to match the geometry of the underlying piece of clothing.

The implementations described herein are based on the concept of “cages” and “meshes.” A body “mesh” (or “render mesh”) is the actual visible geometry of an avatar. A body “mesh” includes graphical representations of body parts such as arms, legs, torso, head parts, etc. and can be of arbitrary shape, size, and geometric topology. Analogously, a clothing “mesh” (or “render mesh”) can be any arbitrary mesh that graphically represents a piece of clothing, such as a shirt, pants, hat, shoes, etc. or parts thereof.

In comparison, a “cage” represents an envelope of features points around the avatar body that is simpler than the body mesh and has weak correspondence to the corresponding vertices of the body mesh. As is explained in further detail later below, a cage may also be used to represent not only the set of feature points on an avatar body, but also a set of feature points on a piece of clothing.

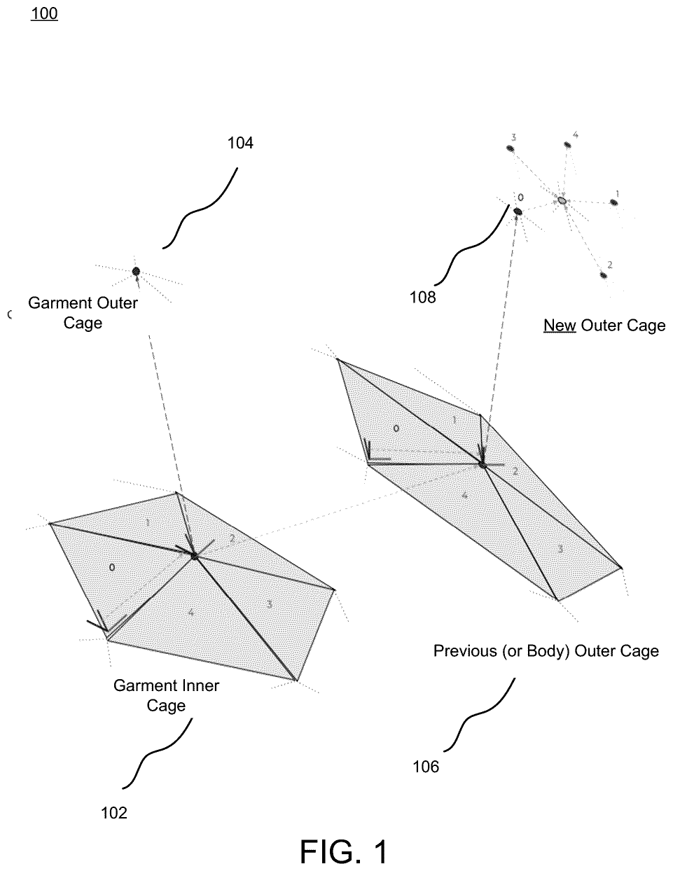

### FIG. 1—Linear Cage Deformer

FIG. 1 is a diagram illustrating an example implementation 100 of a linear cage deformer, in accordance with some implementations. FIG. 1 shows a garment inner cage 102 and an associated garment outer cage 104. Garment inner cage 102 may be associated with a previous (or body) outer cage 106. For example, if a garment being fit is an innermost garment, previous (or body) outer cage 106 is that of an avatar body itself. If a garment being fit is a garment fit on top of one or more inner garments, previous (or body) outer cage 106 is that of the garment immediately preceding the current garment.

Such a previous (or body) outer cage 106 may be used in correspondence with garment inner cage 102 to construct a new (i.e., updated and/or adjusted) outer cage 108 for the current garment based on the original associated garment outer cage 104. The new outer cage 108 may preserve certain properties of the garment inner cage 102 and the garment outer cage 104.

In greater detail, the following techniques may be applied to improve the layering of clothing. The techniques may include iterating over garment cage triangles and sum vertex offsets and weights. Such iterating may include computing, for all or some of the triangles, a difference transform from a previous outer cage (POC) triangle to a garment inner cage (GIC) triangle.

Finding the difference transform may also include computing local three by three matrices for the POC and the GIC triangles. For example, when computing local three by three matrices corresponding to the POC and GIC triangles, vectors u and v may be two triangle edges for each triangle. A vector w may be found as a cross product of vectors u and v. Then, u, v, and w are normalized. The local matrix (for a POC or GIC triangle) may then be obtained by using u, v, and w as basis vectors of a given triangle.

The difference transforms obtain a local difference (LD) as a three by three matrix as a POC matrix multiplied by an inverse of the GIC matrix. To finish computing the difference transform, a transform is applied to the three original corners of an original garment outer cage (GOC) triangle. A local offset vector (LO) is found as a GOC vertex position minus a GIC vertex position. Then, the LO vector is transformed to be a product of the LD matrix, the LO vector, and the GIC triangle area. During the iteration, the transformed LO is added to a vertex offset and a GIC triangle area is added to a vertex weight.

After the iteration over the garment cage triangles, there may be another iteration over vertices of the garment outer cage to compute a final GOC position. For example, for such vertices, final local offsets are found as previously summed vertex offsets (from the iteration) divided by vertex weights (from the iteration). The final position of vertices in the final GOC is found as POC positions plus the final local offsets.

The techniques set forth herein preserve an original spacing and alignment between the garment inner and outer cages when the new outer cage is generated. This improves the quality of the new outer cage, because no extrapolation error is introduced, and the artifacts do not compound as more layers are added.

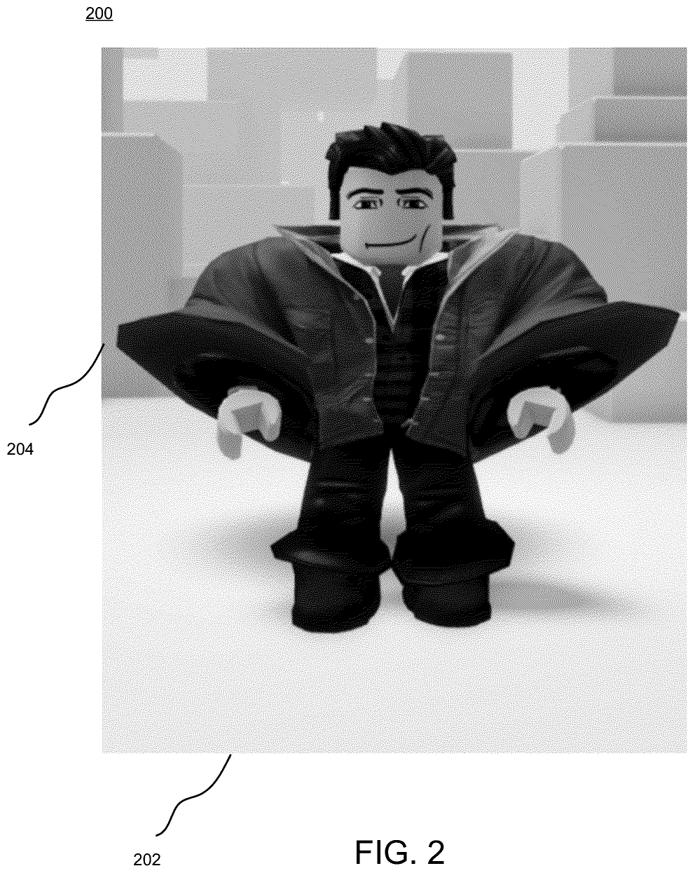

### FIG. 2—Example Avatar

FIG. 2 is a diagram illustrating an example 200 of an avatar 202 with multiple layers of clothing, in accordance with some implementations. The flared cuffs 204 are a compounded extrapolation artifact. Such an extrapolation artifact may occur due to the use of a radial basis function (RBF) technique when layering multiple layers of clothing. Such flared cuffs 204 adversely affect the visual quality of avatar 202.

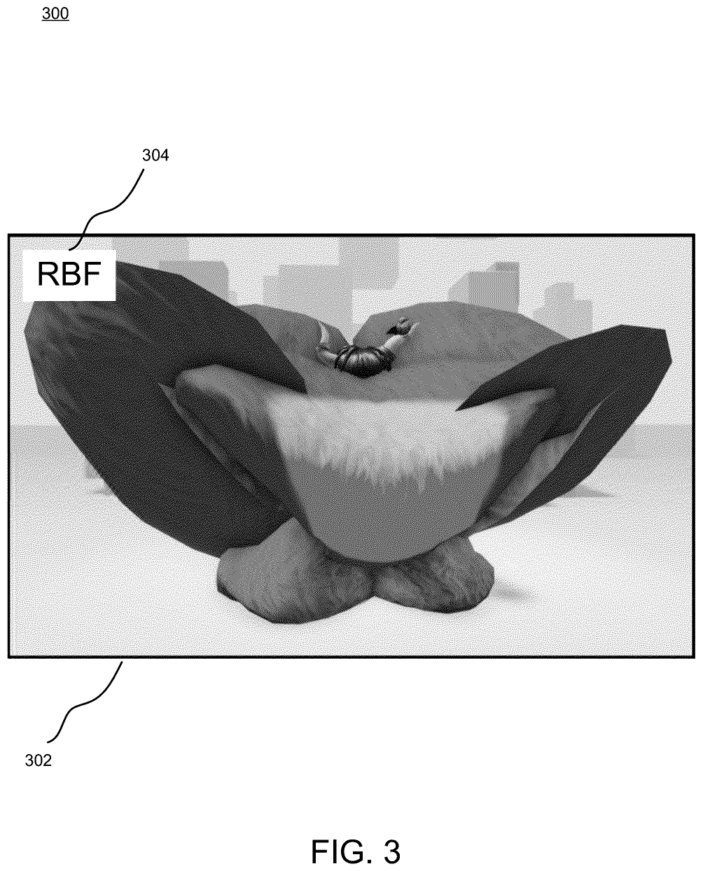

### FIG. 3—Example Avatar

FIG. 3 is a diagram illustrating an example 300 of an avatar 302 with multiple layers of clothing, in accordance with some implementations. The outfit is larger than expected and distorted due to compounding extrapolations. FIG. 3 indicates that avatar 302 is generated with an RBF technique 304. Such distortions adversely affect the visual quality of avatar 302.

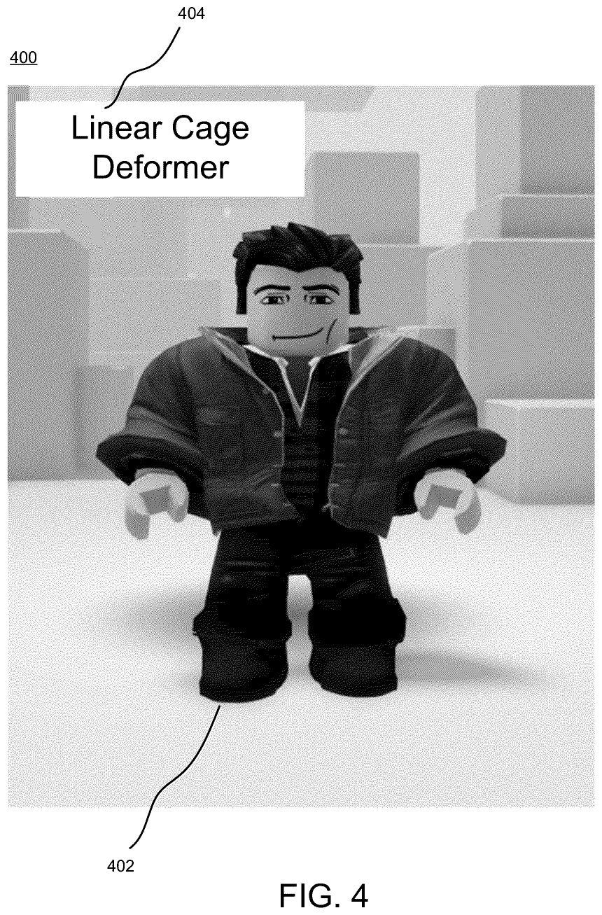

### FIG. 4—Example Avatar

FIG. 4 is a diagram illustrating an example 400 of an avatar 402 with multiple layers of clothing, in accordance with some implementations. The outfit is computed using the linear cage deformer, in accordance with some implementations. FIG. 4 indicates that avatar 402 is generated with a linear cage deformer 404. FIG. 4 illustrates that avatar 402 has clothes with a far more natural fit than those of avatar 202 (as illustrated in FIG. 2), despite there being multiple layers of clothes.

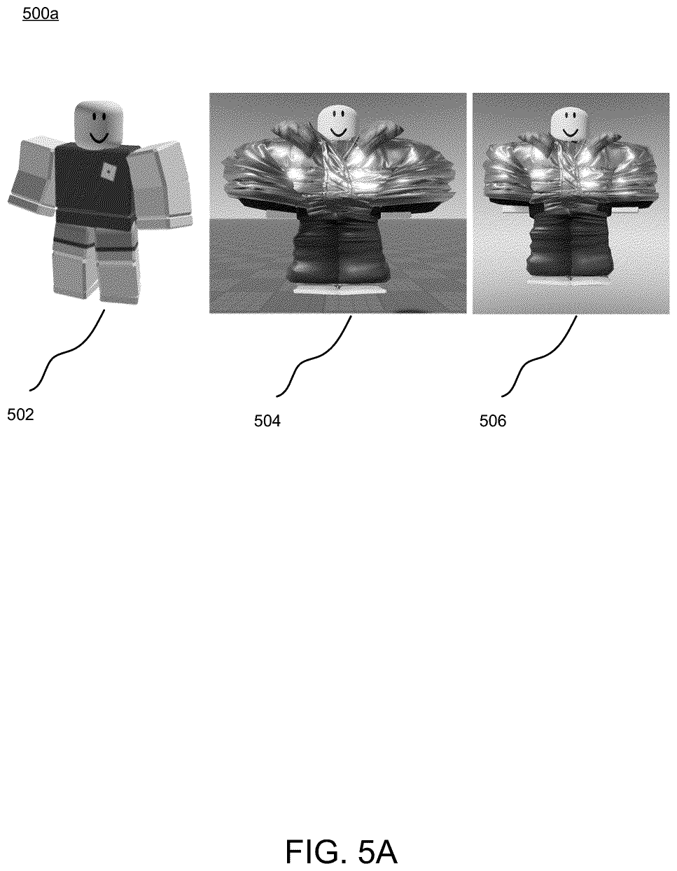

### FIG. 5A—Example Avatar with and without Clothing

FIG. 5A is a diagram illustrating an example 500a of an avatar without clothing and with multiple layers of clothing, comparing existing radial basis function (RBF) techniques to techniques using linear cage deformer techniques, in accordance with some implementations.

For example, avatar 502 may be a default avatar. Using existing clothing layering techniques (such as RBF) may result in avatar 504 having a multi-layered clothing fit that is bulky and inflates the layers as they are placed over each other. However, avatar 506 may use techniques described herein (such as a linear cage deformer) to provide updated fitting using multi-layered techniques presented herein to make avatar 506 look more natural and visually appealing.

### FIG. 5B—Example Avatar with and without Clothing

FIG. 5B is another diagram illustrating an example 500b of an avatar without clothing and with multiple layers of clothing, comparing existing radial basis function (RBF) techniques to techniques using linear cage deformer techniques, in accordance with some implementations.

For example, avatar 512 may be a boy avatar. Avatar 514 generated using existing techniques (such as RBF) may result in an air gap between the sleeve and the arm. Avatar 516 generated using techniques described herein (such as a linear cage deformer) provides a new look with sleeves retaining proportions while properly fitting the arms.

### FIG. 5C—Example Avatar with and without Clothing

FIG. 5C is another diagram illustrating an example 500c of an avatar without clothing and with multiple layers of clothing, comparing existing radial basis function (RBF) techniques to techniques using linear cage deformer techniques, in accordance with some implementations.

For example, avatar 522 may be a woman avatar. Avatar 524 generated using existing techniques (such as RBF) may result in an overly puffy jacket. Avatar 526 generated using techniques described herein (such as a linear cage deformer) provides a new look with a more realistic fit. For example, FIG. 5C also shows that avatar 524 and avatar 526 may differ from avatar 522 in other ways, such as by having hair fit thereon.

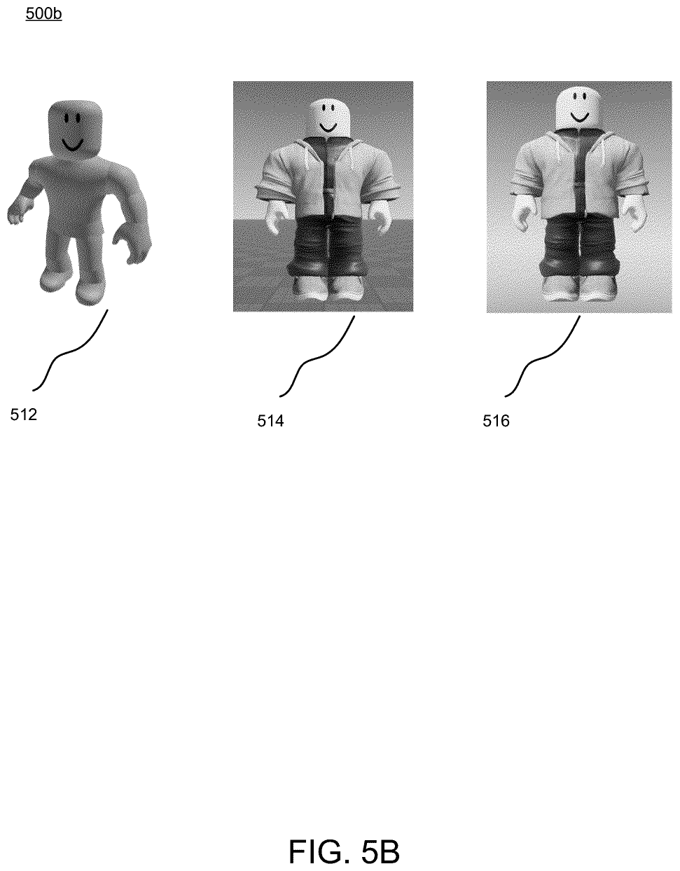

### FIG. 6—Providing 3D Avatar with Multi-Layered Clothing

FIG. 6 illustrates a flowchart of an example computer-implemented method 600 to provide a three-dimensional (3D) avatar with multi-layered clothing in a 3D virtual environment, in accordance with some implementations. Method 600 may begin at block 602.

At block 602, an avatar may be provided in a 3D virtual environment. For example, the avatar may be selected from an avatar repository. the avatar may have an avatar body to be layered with an inner garment and, optionally, one or more outer garments. The avatar may be provided in various ways. Block 602 may be followed by block 604. At block 604 and block 606, an inner garment is layered onto the avatar body.

At block 604, an inner garment is fitted onto the avatar body. For example, such fitting may involve establishing a correspondence between an outer cage of the avatar body and an inner cage of the inner garment and using this correspondence to fit the inner garment onto the avatar body. The inner garment, depending on its type, may be fitted onto one or more portions of the avatar body. For example, a t-shirt may be fitted onto a torso and upper arms of the avatar body. Block 604 may be followed by block 606.

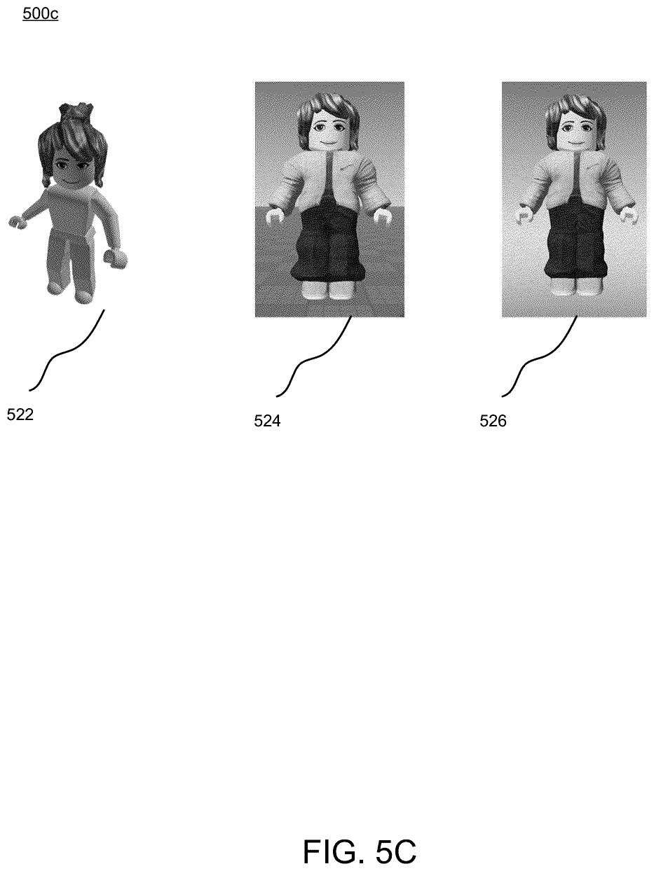

At block 606, an outer cage of the inner garment is deformed. For example, the deforming may use a linear cage deformer technique based on an outer cage of the avatar body and/or an inner cage of the inner garment. Additional details of how block 606 may be performed are illustrated at FIG. 7. Block 606 may be followed by block 608.

However, in some implementations, only a single (inner) garment is fit onto the avatar body and deformed. Thus, in some implementations, block 608 and block 610 are omitted, and the avatar body may be rendered with only the inner garment. However, when multiple garments are placed on an avatar body, block 606 is often followed by block 608.

At block 608 and block 610, an outer garment is layered onto the inner garment.

At block 608, an outer garment is fitted onto an inner garment. For example, such fitting may involve establishing a correspondence between an outer cage of the inner garment and an inner cage of the outer garment and using this correspondence to fit the outer garment onto the inner garment.

The outer garment, depending on its type, may be fitted onto one or more inner garments layered onto portions of the avatar body. For example, a vest may be fitted onto a dress shirt previously layered onto a torso of the avatar body (but not necessarily arms of the avatar body). Block 608 may be followed by block 610.

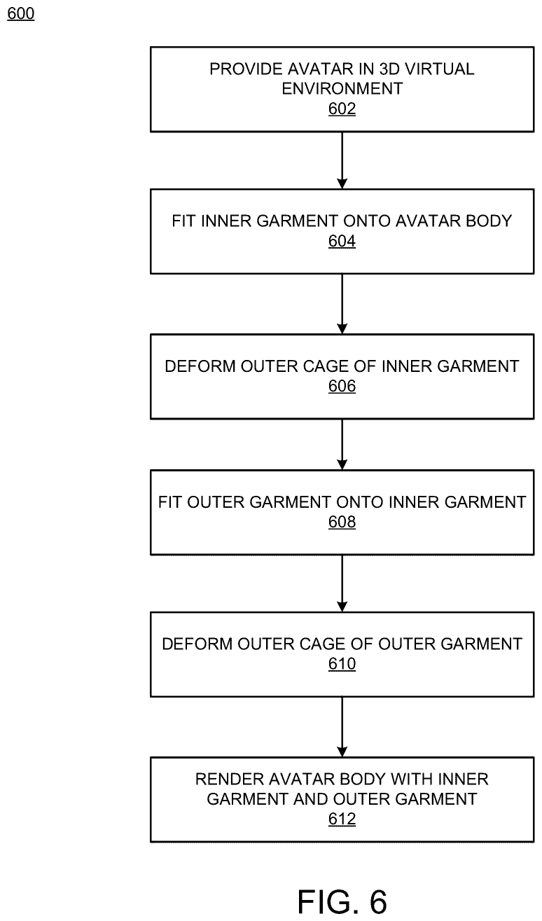

At block 610, an outer cage of the outer garment is deformed. For example, the deforming may use a linear cage deformer technique based on the deformed outer cage of the inner garment and/or an inner cage of the outer garment. Additional details of how block 610 may be performed are illustrated at FIG. 8. Such deforming improves the fit of the outer garment onto the avatar body and the inner garment and also aids in fitting subsequent garments onto the avatar body. Block 610 may be followed by block 612 for rendering.

However, in some implementations, there may be more than two layers of garments. In such implementations, after fitting the outer garment onto the inner garment at block 608 and deforming the outer cage of outer garment at block 610, other garments may be layered onto the existing garments sequentially. Such layering includes fitting a next garment onto an immediately previous garment and deforming the next garment's outer cage to render and/or fit a next garment.

At block 612, the avatar body may be rendered with the inner garment and the outer garment. If there are two or more garments, at block 612, the avatar body may be rendered with all or some of the layered garments.

### FIG. 7—Adjusting Outer Cage Vertex of Outer Cage of Inner Garment

FIG. 7 illustrates a flowchart of an example computer-implemented method 700 to adjust a position of an outer cage vertex of an outer cage of an inner garment, in accordance with some implementations. Method 700 may begin at block 702.

At block 702, a corresponding vertex on an outer cage of an avatar body and an inner cage of an inner garment is identified. For example, such a corresponding vertex is identified based on finding a relationship based on where the outer cage of the avatar body the inner cage of the inner garment is to fit. Such a corresponding vertex may serve as the basis of deforming the outer cage of the inner garment. Block 702 may be followed by block 704.

At block 704, a local coordinate frame of the inner cage of the inner garment is generated. For example, the local coordinate frame of the inner cage of the inner garment may be generated based on triangles that share the identified vertex. Block 704 may be followed by block 706.

At block 706, a local coordinate frame of the outer cage of the avatar body is generated. For example, the local coordinate frame of the outer cage of the avatar body may be generated based on triangles that share the identified vertex. Block 706 may be followed by block 708.

At block 708, a position of a corresponding vertex is adjusted. For example, the adjustment may be based on a difference between the local coordinate frame of the inner cage of the inner cage of the inner garment and the local coordinate frame of the outer cage of the avatar body. By using this difference, it may be possible to preserve the original spacing and alignment between the inner garment inner and outer cages when generating the new outer cage for the inner garment.

### FIG. 8—Adjusting Outer Cage Vertex of Outer Cage of Outer Garment

FIG. 8 illustrates a flowchart of an example computer-implemented method 800 to adjust a position of an outer cage vertex of an outer cage of an outer garment, in accordance with some implementations. Method 800 may begin at block 802.

At block 802, a corresponding vertex on an outer cage of an inner garment and an inner cage of an outer garment is identified. For example, such a corresponding vertex is identified based on finding a relationship based on where on the outer cage of the inner garment the inner cage of the outer garment is to fit. Such a corresponding vertex may serve as the basis of deforming the outer cage of the outer garment. Block 802 may be followed by block 804.

At block 804, a local coordinate frame of the inner cage of the outer garment is generated. For example, the local coordinate frame of the inner cage of the outer garment may be generated based on triangles that share the identified vertex. Block 804 may be followed by block 806.

At block 806, a local coordinate frame of the outer cage of the inner garment is generated. For example, the local coordinate frame of the outer cage of the inner garment may be generated based on triangles that share the identified vertex. Block 806 may be followed by block 808.

At block 808, a position of a corresponding vertex is adjusted. For example, the adjustment may be based on a difference between the local coordinate frame of the inner cage of the outer garment and the local coordinate frame of the outer cage of the inner garment. By using this difference, it may be possible to preserve the original spacing and alignment between the outer garment inner and outer cages when generating the new outer cage for the outer garment.

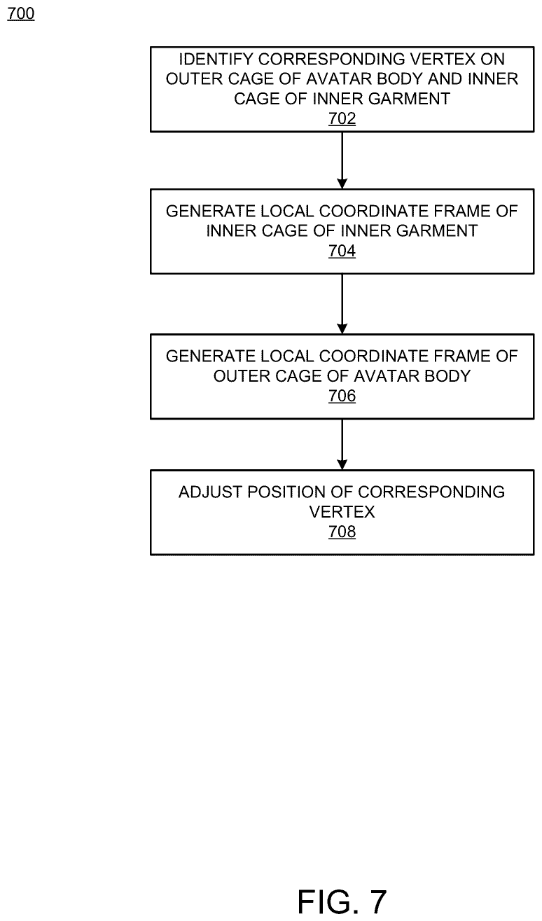

### FIG. 9—Deforming Outer Cage of Inner Garment

FIG. 9 illustrates a flowchart of an example computer-implemented method 900 to deform an outer cage of an inner garment, in accordance with some implementations. Method 900 may begin at block 902.

At block 902, a first dataset is determined (i.e., first dataset values are determined). Such a first dataset may describe a volume taken up by an unclothed body part of an avatar (e.g., a torso). The first dataset may help identify a relationship between the avatar and the clothing layered thereon. Block 902 may be followed by block 904.

At block 904, a second dataset is determined (i.e., second dataset values are determined). Such a second dataset may describe a volume taken up by a clothing item (e.g., a shirt) layered over the unclothed body part of the avatar. The second dataset may also help identify a relationship between the avatar and the clothing layered thereon. Block 904 may be followed by block 906.

At block 906, differences between corresponding values in the first dataset and the values in the second dataset are calculated. Thus, each difference may indicate a discrepancy between a vertex in the first dataset (which corresponds to the avatar body) and a vertex in the second dataset (which corresponds to the clothing item). Block 906 may be followed by block 908.

At block 908, sums from the calculated differences and values in the second dataset are calculated to deform the outer cage of the inner garment. Such sums preserve spacing and alignment between garment inner and outer cages when generating an adjusted outer cage for the garment.

While FIG. 9 pertains to an example in which volume datasets are identified and used for an avatar body and an initial piece of clothing, similar operations may be used to establish volumes for a piece of layered clothing and a subsequent piece of layered clothing, and differences of these volumes can be summed with values from datasets to deform outer cages of successive layers of clothing.

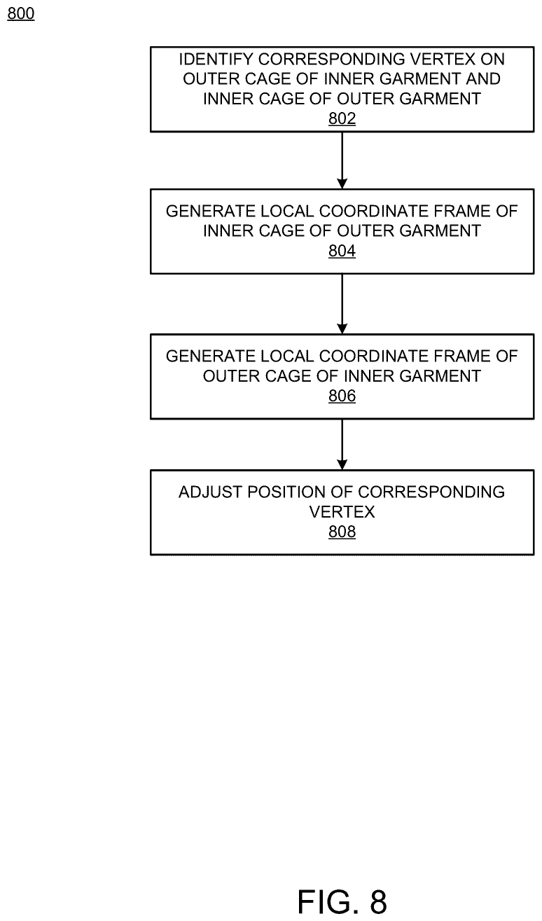

### FIG. 10—Deforming Outer Cage of Garment

FIG. 10 illustrates a flowchart of an example computer-implemented method 1000 to deform an outer cage of a garment, in accordance with some implementations. Method 1000 may begin at block 1002.

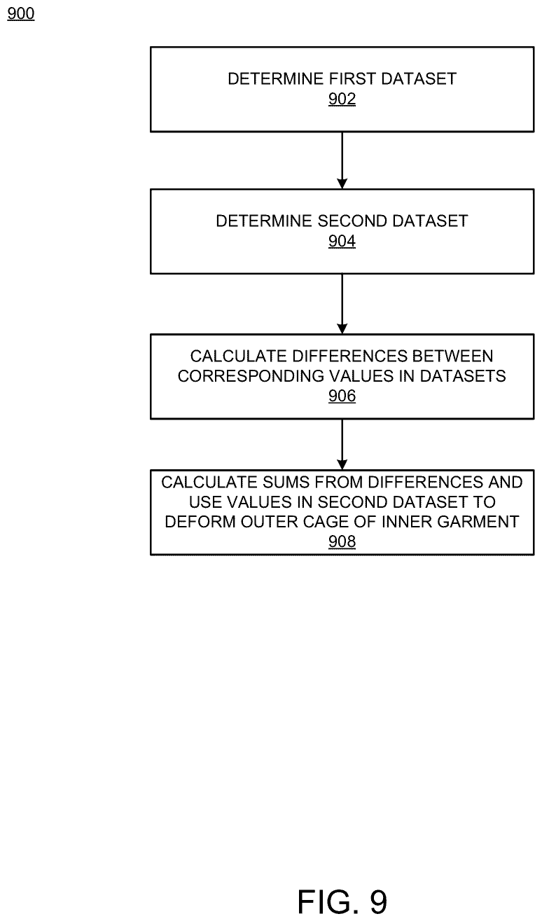

At block 1002, garment cage triangles are iterated over while summing vertex offsets and weights. Additional details of such an iteration with respect to triangles are presented in FIG. 11. Such iteration gathers information about relationships between previous outer cage (POC) triangles and garment inner cage (GIC) triangles and what transformations may be appropriate for garment outer cage (GOC) triangles. Block 1002 may be followed by block 1004.

At block 1004, final local offsets are found. Such final local offsets may be found by taking a previously summed vertex offset for each vertex (as found in block 1002) and dividing the summed vertex offset by a corresponding vertex weight (also as found in block 1002). Because block 1002 iterates over the garment triangles, after the iterating, the summed vertex offset and the vertex weight reflect how to transform GOC vertices into vertices for a deformed garment outer cage used for updating an outer cage of the garment. Block 1004 may be followed by block 1006.

At block 1006, an outer cage of the garment may be deformed based on a deformed garment outer cage determined from iterating over vertices of the outer cage. For example, the vertices in the outer cage of the garment may be adjusted to have a final position that is found from the corresponding POC vertices plus the final local offsets calculated at block 1004.

Using such final offsets provides for new vertex positions for vertices of the outer cage with the technical advantages discussed above (e.g., preserving original spacing and alignment without introducing extrapolation error, thus improving quality and avoiding compounded artifacts).

### FIG. 11—Updating Vertex Offsets and Weights of Garment Outer Cage (GOC) Triangles

FIG. 11 illustrates a flowchart of an example computer-implemented method 1100 to update vertex offsets and weights of garment outer cage (GOC) triangles, in accordance with some implementations. Method 1100 may begin at block 1102.

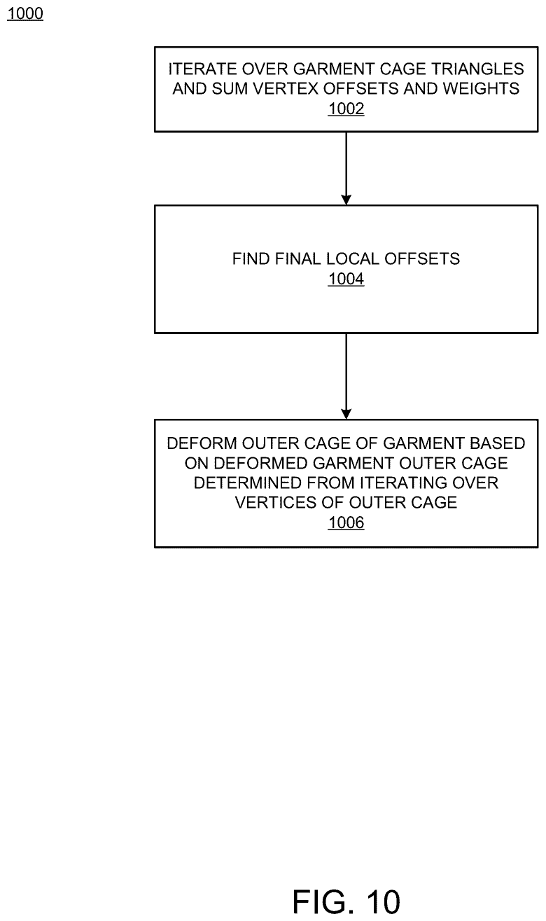

At block 1102, difference transforms from POC triangles to GIC triangles may be computed. The difference transforms may be found by computing local matrices and finding a product based on the matrices. Additional details of block 1102 are presented in FIG. 12. Block 1102 may be followed by block 1104.

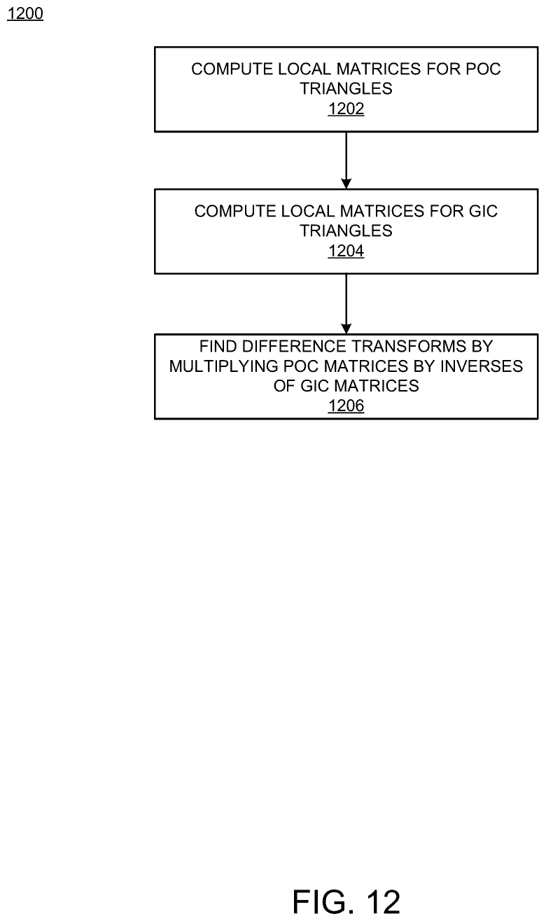

At block 1104, vertices of GOC triangles are transformed based on the difference transforms. There may be local offset vectors, which are modified prior to use in a transformation. Additional details of block 1104 are presented in FIG. 14. Block 1104 may be followed by block 1106.

At block 1106, vertex offsets and weights of GOC triangles are updated. Vertex offsets may be updated based on local offsets and vertex weights may be updated based on triangle areas. Additional details of block 1106 are presented in FIG. 14. After block 1106, the iterating of block 1002 may be complete and method 1000 of FIG. 10 may continue with finding final local offsets at block 1004.

### FIG. 12—Finding Difference Transforms

FIG. 12 illustrates a flowchart of an example computer-implemented method 1200 to find difference transforms, in accordance with some implementations. Method 1200 may begin at block 1202.

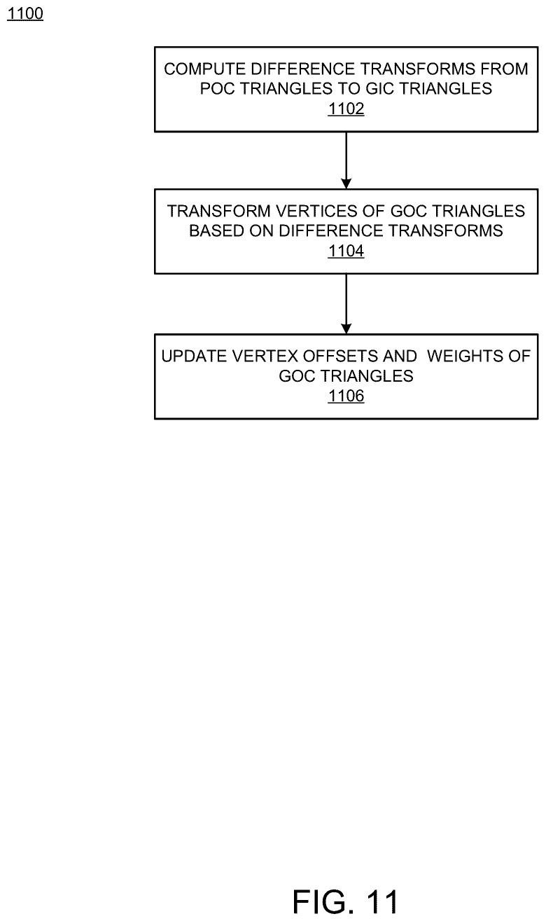

At block 1202, local matrices for POC triangles are computed by using vectors corresponding to the triangles. Details of block 1202 are presented in FIG. 13 (with respect to how to obtain a local matrix as used herein for a given triangle). Block 1202 may be followed by block 1204.

At block 1204, local matrices for GIC triangles are computed by using vectors corresponding to the triangles. Details of block 1204 are presented in FIG. 13 (with respect to how to obtain a local matrix as used herein for a given triangle). Block 1204 may be followed by block 1206.

At block 1206, difference transforms may be found by multiplying the local metrices for the POC triangles by inverses of the local matrices for the GIC triangles. The result of this multiplying is a three by three matrix that can be used for difference transforms.

### FIG. 13—Obtaining Local Matrices from Vectors

FIG. 13 illustrates a flowchart of an example computer-implemented method 1300 to obtain local matrices from vectors, in accordance with some implementations. Method 1300 may begin at block 1302.

At block 1302, a first vector and a second vector may be found. For example, the first vector and the second vector may define a triangle, such as for a POC triangle or a GIC triangle whose local matrix is being obtained. The first vector and the second vector may be edges of the current triangle. For example, the first vector may be referred to as u, and the second vector may be referred to as v.

At block 1304, a third vector may be found as a cross product (or vector product) of u and v. Such a third vector may be referred to as a vector w.

At block 1306, the three vectors (u, v, and w) are normalized. That is, each vector retains its direction while being transformed into a unit vector (i.e., the length of the vector is one linear unit).

At block 1308, a local matrix having the vectors as basis vectors is obtained. Such a matrix may be obtained using linear algebra techniques to identify the local matrix.

### FIG. 14—Updating Vertex Offsets and Vertex Weights

FIG. 14 illustrates a flowchart of an example computer-implemented method 1400 to update vertex offsets and vertex weights, in accordance with some implementations. Method 1400 may begin at block 1402.

At block 1402, original local offset vectors are found. For example, a local offset (LO) vector may be found as a GOC vertex position minus a GIC vertex position. Hence, an original LO vector may represent an original offset between an outer cage vertex of a garment and an inner cage vertex of a garment. Block 1402 may be followed by block 1404.

At block 1404, the original local offset vectors are transformed. Such a transformation is based on finding a product of the LD matrix (found as illustrated in FIGS. 12 and 13) multiplied by the original LO matrix multiplied by a GIC triangle area (such an area may be found using vector products based on vectors defining edges of a triangle). Block 1404 may be followed by block 1406.

At block 1406, the transformed local offset vectors are added to vertex offsets (as a running sum). Block 1406 may be followed by block 1408.

At block 1408, the areas of GIC triangles are added to vertex weights (as a running sum).

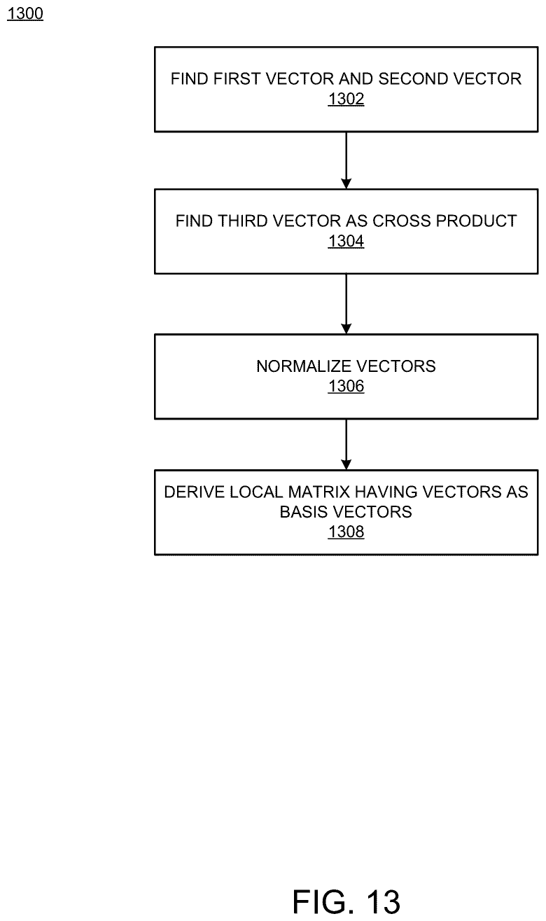

### FIG. 15—System Architecture

FIG. 15 is a diagram of an example system architecture that includes a 3D environment platform that can support 3D avatars with multi-layered clothing, in accordance with some implementations. FIG. 15 and the other figures use like reference numerals to identify similar elements. A letter after a reference numeral, such as “1510,” indicates that the text refers specifically to the element having that particular reference numeral. A reference numeral in the text without a following letter, such as “1510,” refers to any or all of the elements in the figures bearing that reference numeral (e.g., “1510” in the text refers to reference numerals “1510a,” “1510b,” and/or “1510n” in the figures).

The system architecture 1500 (also referred to as “system” herein) includes online virtual experience server 1502, data store 1520, client devices 1510a, 1510b, and 1510n (generally referred to as “client device(s) 1510” herein), and developer devices 1530a and 1530n (generally referred to as “developer device(s) 1530” herein). Virtual experience server 1502, data store 1520, client devices 1510, and developer devices 1530 are coupled via network 1522. In some implementations, client devices(s) 1510 and developer device(s) 1530 may refer to the same or same type of device.

Online virtual experience server 1502 can include, among other things, a virtual experience engine 1504, one or more virtual experiences 1506, and graphics engine 1508. In some implementations, the graphics engine 1508 may be a system, application, or module that permits the online virtual experience server 1502 to provide graphics and animation capability. In some implementations, the graphics engine 1508 and/or virtual experience engine 1504 may perform one or more of the operations described below in connection with the flowcharts shown in FIGS. 6-14, 20-24, and 28-29. A client device 1510 can include a virtual experience application 1512, and input/output (I/O) interfaces 1514 (e.g., input/output devices). The input/output devices can include one or more of a microphone, speakers, headphones, display device, mouse, keyboard, game controller, touchscreen, virtual reality consoles, etc.

A developer device 1530 can include a virtual experience application 1532, and input/output (I/O) interfaces 1534 (e.g., input/output devices). The input/output devices can include one or more of a microphone, speakers, headphones, display device, mouse, keyboard, game controller, touchscreen, virtual reality consoles, etc.

System architecture 1500 is provided for illustration. In different implementations, the system architecture 1500 may include the same, fewer, more, or different elements configured in the same or different manner as that shown in FIG. 15.

In some implementations, network 1522 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 1520 may be a non-transitory computer readable memory (e.g., random access memory), a cache, a drive (e.g., a hard drive), a flash drive, a database system, or another type of component or device capable of storing data. The data store 1520 may also include multiple storage components (e.g., multiple drives or multiple databases) that may also span multiple computing devices (e.g., multiple server computers). In some implementations, data store 1520 may include cloud-based storage.

In some implementations, the online virtual experience server 1502 can include a server having one or more computing devices (e.g., a cloud computing system, a rackmount server, a server computer, cluster of physical servers, etc.). In some implementations, the online virtual experience server 1502 may be an independent system, may include multiple servers, or be part of another system or server.

In some implementations, the online virtual experience server 1502 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 1502 and to provide a user with access to online virtual experience server 1502. The online virtual experience server 1502 may also include a website (e.g., a web page) or application back-end software that may be used to provide a user with access to content provided by online virtual experience server 1502. For example, users may access online virtual experience server 1502 using the virtual experience application 1512 on client devices 1510.

In some implementations, virtual experience session data are generated via online virtual experience server 1502, virtual experience application 1512, and/or virtual experience application 1532, and are stored in data store 1520. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 1502 may be a type of social network providing connections between users or a type of user-generated content system that allows users (e.g., end-users or consumers) to communicate with other users on the online virtual experience server 1502, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 1520 or within virtual experiences 1506. The data store 1520 may be utilized to store chat transcripts (text, audio, images, etc.) exchanged between participants, with appropriate permissions from the players and in compliance with applicable regulations.

In some implementations, the chat transcripts are generated via virtual experience application 1512 and/or virtual experience application 1532 or and are stored in data store 1520. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 1520.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 1502 may be a virtual gaming server. For example, the gaming server may provide single-player or multiplayer games to a community of users that may access as “system” herein) includes online virtual experience server 1502, data store 1520, client or interact with virtual experiences using client devices 1510 via network 1522. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 1510) within a virtual experience (e.g., 1506) or the presentation of the interaction on a display or other output device (e.g., 1514) of a client device 1510. For example, virtual experience engagement may include interactions with one or more participants within a virtual experience or the presentation of the interactions on a display of a client device.

In some implementations, a virtual experience 1506 can include an electronic file that can be executed or loaded using software, firmware or hardware configured to present the virtual experience content (e.g., digital media item) to an entity. In some implementations, a virtual experience application 1512 may be executed and a virtual experience 1506 rendered in connection with a virtual experience engine 1504. In some implementations, a virtual experience 1506 may have a common set of rules or common goal, and the environment of a virtual experience 1506 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 1506 may be collectively referred to as a “world” or “virtual experience world” or “gaming world” or “virtual world” or “universe” herein. An example of a world may be a 3D world of a virtual experience 1506. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 1502 can host one or more virtual experiences 1506 and can permit users to interact with the virtual experiences 1506 using a virtual experience application 1512 of client devices 1510. Users of the online virtual experience server 1502 may play, create, interact with, or build virtual experiences 1506, communicate with other users, and/or create and build objects (e.g., also referred to as “item(s)” or “virtual experience objects” or “virtual experience item(s)” herein) of virtual experiences 1506.

For example, in generating user-generated virtual items, users may create characters, decoration for the characters, one or more virtual environments for an interactive virtual experience, or build structures used in a virtual experience 1506, among others. In some implementations, users may buy, sell, or trade virtual experience objects, such as in-platform currency (e.g., virtual currency), with other users of the online virtual experience server 1502. In some implementations, online virtual experience server 1502 may transmit virtual experience content to virtual experience applications (e.g., 1512). In some implementations, virtual experience content (also referred to as “content” herein) may refer to any data or software instructions (e.g., virtual experience objects, virtual experience, user information, video, images, commands, media item, etc.) associated with online virtual experience server 1502 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience 1506 of the online virtual experience server 1502 or virtual experience applications 1512 of the client devices 1510. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 1502 hosting virtual experiences 1506, is provided for purposes of illustration. In some implementations, online virtual experience server 1502 may host one or more media items that can include communication messages from one user to one or more other users. With user permission and express user consent, the online virtual experience server 1502 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 1506 may be associated with a particular user or a particular group of users (e.g., a private virtual experience), or made widely available to users with access to the online virtual experience server 1502 (e.g., a public virtual experience). In some implementations, where online virtual experience server 1502 associates one or more virtual experiences 1506 with a specific user or group of users, online virtual experience server 1502 may associate the specific user(s) with a virtual experience 1506 using user account information (e.g., a user account identifier such as username and password).

In some implementations, online virtual experience server 1502 or client devices 1510 may include a virtual experience engine 1504 or virtual experience application 1512. In some implementations, virtual experience engine 1504 may be used for the development or execution of virtual experiences 1506. For example, virtual experience engine 1504 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 1504 may generate commands that help compute and render the virtual experience (e.g., rendering commands, collision commands, physics commands, etc.) In some implementations, virtual experience applications 1512 of client devices 1510, respectively, may work independently, in collaboration with virtual experience engine 1504 of online virtual experience server 1502, or a combination of both.

In some implementations, both the online virtual experience server 1502 and client devices 1510 may execute a virtual experience engine/application (1504 and 1512, respectively). The online virtual experience server 1502 using virtual experience engine 1504 may perform some or all the virtual experience engine functions (e.g., generate physics commands, rendering commands, etc.), or offload some or all the virtual experience engine functions to virtual experience engine 1504 of client device 1510. In some implementations, each virtual experience 1506 may have a different ratio between the virtual experience engine functions that are performed on the online virtual experience server 1502 and the virtual experience engine functions that are performed on the client devices 1510. For example, the virtual experience engine 1504 of the online virtual experience server 1502 may be used to generate physics commands in cases where there is a collision between at least two virtual experience objects, while the additional virtual experience engine functionality (e.g., generate rendering commands) may be offloaded to the client device 1510. In some implementations, the ratio of virtual experience engine functions performed on the online virtual experience server 1502 and client device 1510 may be changed (e.g., dynamically) based on virtual experience engagement conditions. For example, if the number of users engaging in a particular virtual experience 1506 exceeds a threshold number, the online virtual experience server 1502 may perform one or more virtual experience engine functions that were previously performed by the client devices 1510.

For example, users may be playing a virtual experience 1506 on client devices 1510, and may send control instructions (e.g., user inputs, such as right, left, up, down, user election, or character position and velocity information, etc.) to the online virtual experience server 1502. Subsequent to receiving control instructions from the client devices 1510, the online virtual experience server 1502 may send experience instructions (e.g., position and velocity information of the characters participating in the group experience or commands, such as rendering commands, collision commands, etc.) to the client devices 1510 based on control instructions. For instance, the online virtual experience server 1502 may perform one or more logical operations (e.g., using virtual experience engine 1504) on the control instructions to generate experience instruction(s) for the client devices 1510. In other instances, online virtual experience server 1502 may pass one or more or the control instructions from one client device 1510 to other client devices (e.g., from client device 1510a to client device 1510b) participating in the virtual experience 1506. The client devices 1510 may use the experience instructions and render the virtual experience for presentation on the displays of client devices 1510.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 1502. In other implementations, the control instructions may be sent from a client device 1510 to another client device (e.g., from client device 1510b to client device 1510n), where the other client device generates experience instructions using the local virtual experience engine 1504. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 1510 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 1510 may be used.

In some implementations, each client device 1510 may include an instance of the virtual experience application 1512, respectively. In one implementation, the virtual experience application 1512 may permit users to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 1510 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 1502 as well as interact with online virtual experience server 1502 (e.g., engage in virtual experiences 1506 hosted by online virtual experience server 1502). As such, the virtual experience application may be provided to the client device(s) 1510 by the online virtual experience server 1502. In another example, the virtual experience application may be an application that is downloaded from a server.

In some implementations, each developer device 1530 may include an instance of the virtual experience application 1532, respectively. In one implementation, the virtual experience application 1532 may permit a developer user(s) to use and interact with online virtual experience server 1502, such as control a virtual character in a virtual experience hosted by online virtual experience server 1502, or view or upload content, such as virtual experiences 1506, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 1530 and allows users to interact with online virtual experience server 1502. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 1532 may be an online virtual experience server application for users to build, create, edit, upload content to the online virtual experience server 1502 as well as interact with online virtual experience server 1502 (e.g., provide and/or engage in virtual experiences 1506 hosted by online virtual experience server 1502). As such, the virtual experience application may be provided to the developer device(s) 1530 by the online virtual experience server 1502. In another example, the virtual experience application 1532 may be an application that is downloaded from a server. Virtual experience application 1532 may be configured to interact with online virtual experience server 1502 and obtain access to user credentials, user currency, etc. for one or more virtual experiences 1506 developed, hosted, or provided by a virtual experience developer.

In some implementations, a user may login to online virtual experience server 1502 via the virtual experience application. The user may access a user account by providing user account information (e.g., username and password) where the user account is associated with one or more characters available to participate in one or more virtual experiences 1506 of online virtual experience server 1502. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 1502 can also be performed by the client device(s) 1510, or a server, in other implementations if appropriate. In addition, the functionality attributed to a particular component can be performed by different or multiple components operating together. The online virtual experience server 1502 can also be accessed as a service provided to other systems or devices through suitable application programming interfaces (APIs), and thus is not limited to use in websites.

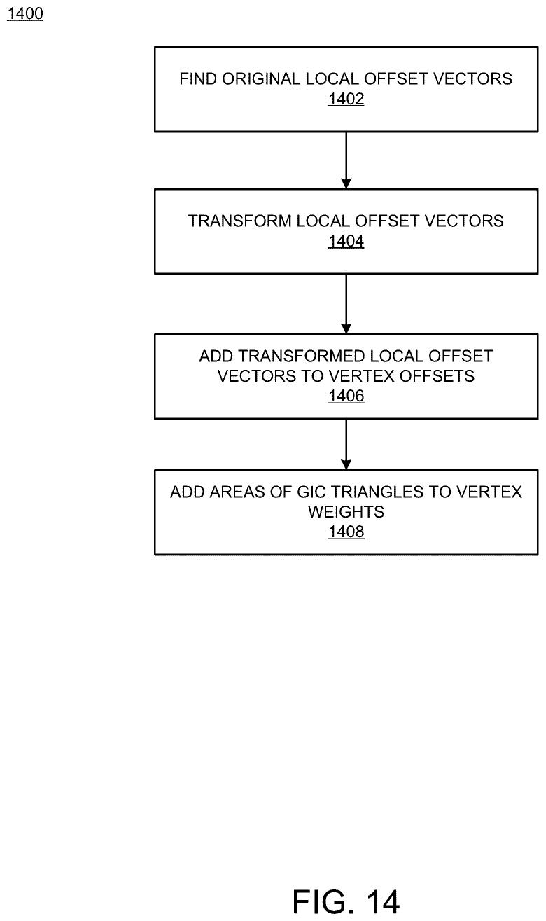

### FIG. 16—Example Computing Device

FIG. 16 is a block diagram that illustrates an example computing device 1600 which may be used to implement one or more features described herein, in accordance with some implementations. In one example, computing device 1600 may be used to implement a computer device (e.g., 1502 and/or 1510 of FIG. 15), and perform appropriate method implementations described herein. Computing device 1600 can be any suitable computer system, server, or other electronic or hardware device. For example, the computing device 1600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1600 includes a processor 1602, a memory 1604, input/output (I/O) interface 1606, and audio/video input/output devices 1614.

Processor 1602 can be one or more processors and/or processing circuits to execute program code and control basic operations of the computing device 1600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1604 is typically provided in computing device 1600 for access by the processor 1602, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1602 and/or integrated therewith. Memory 1604 can store software operating on the computing device 1600 by the processor 1602, including an operating system 1608, a virtual experience application 1610, a clothing fitting application 1612, and other applications (not shown). In some implementations, virtual experience application 1610 and/or clothing fitting application 1612 can include instructions that enable processor 1602 to perform the functions (or control the functions of) described herein, e.g., some or all of the methods described with respect to FIGS. 6-14, 20-24, and 28-29.

For example, virtual experience application 1610 can include a clothing fitting application 1612, which as described herein can layer multiple layers of clothing onto an avatar and render the avatar within an online virtual experience server (e.g., 1502). Elements of software in memory 1604 can alternatively be stored on any other suitable storage location or computer-readable medium. In addition, memory 1604 (and/or other connected storage device(s)) can store instructions and data used in the features described herein. Memory 1604 and any other type of storage (magnetic disk, optical disk, magnetic tape, or other tangible media) can be considered “storage” or “storage devices.”

I/O interface(s) 1606 can provide functions to enable interfacing the computing device 1600 with other systems and devices. For example, network communication devices, storage devices (e.g., memory and/or data store 1520), and input/output devices can communicate via I/O interface(s) 1606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1614 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 16 shows one block for each of processor 1602, memory 1604, I/O interface(s) 1606, and software blocks of operating system 1608, virtual experience application 1610, and clothing fitting application 1612. These blocks may represent one or more processors or processing circuitries, operating systems, memories, I/O interfaces, applications, and/or software engines. In other implementations, computing device 1600 may not have all of the components shown and/or may have other elements including other types of elements instead of, or in addition to, those shown herein. While the online virtual experience server 1502 is described as performing operations as described in some implementations herein, any suitable component or combination of components of online virtual experience server 1502 or similar system, or any suitable processor or processors associated with such a system, may perform the operations described.

A user device can also implement and/or be used with features described herein. Example user devices can be computer devices including some similar components as the computing device 1600, e.g., processor(s) 1602, memory 1604, and I/O interface(s) 1606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1614, for example, can be connected to (or included in) the computing device 1600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 600, 700, 800, 900, 1000, 1100, 1200, 1300, 1400, 2000, 2100, 2200, 2300, 2400, 2800, and 2900) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

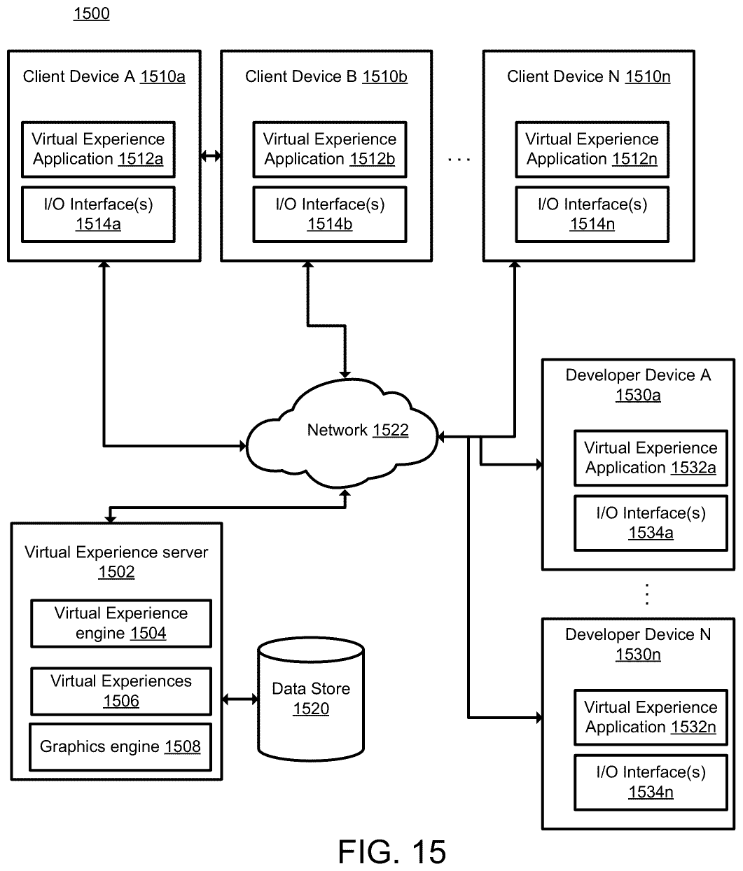

### FIG. 17—Example Cages

FIG. 17 illustrates examples of cages under a linear deformer which experience crossover and spikes 1700.

A linear deformer is a technique to deform an outer cage of a garment to a character body, such as a three-dimensional (3D) avatar. A linear deformer constructs an affine transform of a point (e.g., a point on a cage) based on the relative positions of its neighboring points and the normals of adjacent faces. While cages deformed using a linear deformer may have less flaring issues (where adding multiple layers causes flaring) than when cage deformation is performed using a radial basis function (RBF), a linear deformer fails to address other issues. A linear deformer also has some problems with respect to affine transformations in certain directions with reference to a cage.

One problem with the use of a linear deformer is crossover for continuous cages, such as those for skirts and dresses, that are dissimilar to the inner cage topology. For example, skirts and dresses have a seam in the middle as part of their cage definition.

A linear deformer treats the two halves of a skirt as two legs, according to the humanoid topology of the avatar outer cage and garment inner cage. Thus, there is some crossover in the center of the deformed cage where the seam of the skirt is to be. This issue can be especially problematic for transformations where the pose of the garment cage is different from the pose of the avatar.

FIG. 17 illustrates cage 1710 and cage 1720, where cage 1710 and cage 1720 are examples of cages for dresses under a linear deformer that experience crossover and spikes. These examples illustrate that without using the techniques discussed herein, there can be significant quality issues when rendering a garment such as a skirt or a dress. By using techniques discussed herein, it may be possible to better handle these quality issues.

Various implementations described herein incorporate multiple influences on the deformation of each point. In some implementations, a rotation is computed at each point using the normals of adjacent faces to transform the point from the garment coordinate system to the avatar coordinate system. Then, a set of weighted translations is computed for each point based on the points that influence the point.

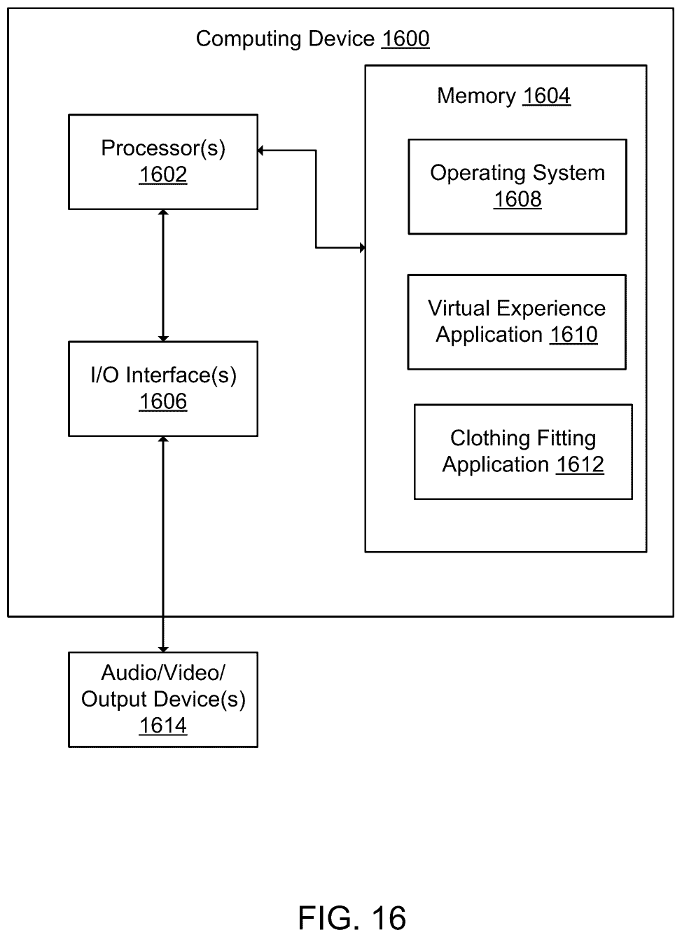

### FIG. 18—Outer Cage with Crossover and Linear Deformer

FIG. 18 illustrates a garment 1810 with an outer cage and geometry and a corresponding outer cage 1820 with crossover and a linear deformer outer cage 1830.

FIGS. 17-20, as well as other portions of the disclosure, describe a modification to alternative linear deformer techniques, where the modification may improve the quality of results.

For example, FIG. 18 illustrates a garment outer cage and geometry 1810, including geometry 1812 and outer cage 1814. For example, geometry 1812 corresponds to a skirt layered over an entire avatar defined by outer cage 1814. FIG. 18 also illustrates a corresponding outer cage with crossover 1820 and a corresponding linear deformer outer cage 1830. This example illustrates that the linear deformer outer cage 1830 constructed using techniques discussed in the present disclosure is a better outer cage than outer cage with crossover 1820 when modeling a skirt with a seam in that it avoids modeling defects that might otherwise occur. Outer cage with crossover 1820 shows a cage that was deformed using an alternative linear deformer approach, and the linear deformer outer cage 1830 shows a linear deformer approach with some improvements. For example, there is a triangular region at the bottom of outer cage with crossover 1820 that is not present in the linear deformer outer cage 1830 and that triangular region is not meant to be there.

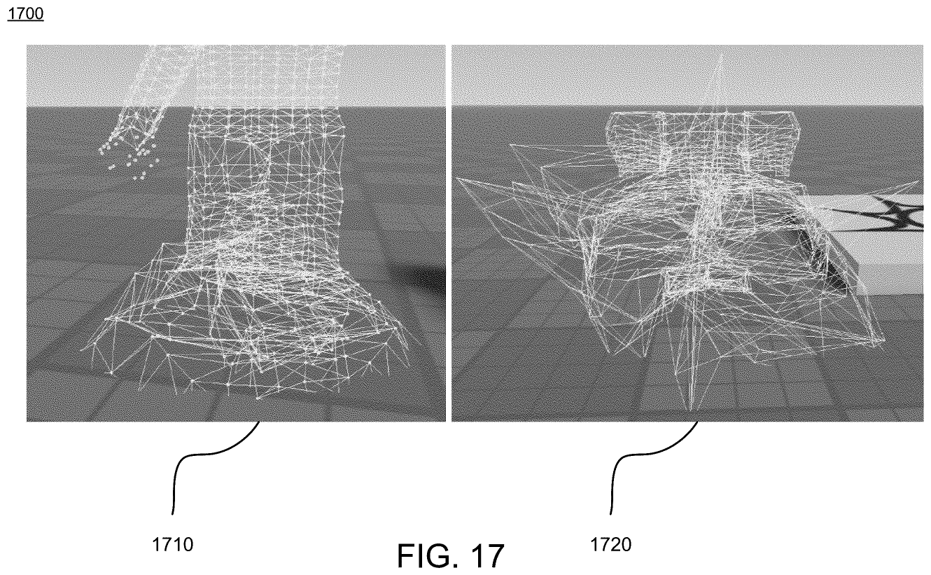

### FIG. 19—Geometry with Crossover and Linear Deformer

FIG. 19 illustrates a garment with an outer cage and geometry and a corresponding geometry with crossover and a linear deformer geometry.

For example, FIG. 19 illustrates a garment outer cage and geometry 1910, including geometry 1912 and outer cage 1914. For example, geometry 1912 corresponds to a skirt layered over an entire avatar defined by outer cage 1914. FIG. 19 also illustrates the corresponding geometry fitted on a different avatar. Corresponding geometry with crossover 1920 illustrates the resulting skirt as fitted by the linear deformer without radial search, showing crossover artifacts between the legs. Corresponding linear deformer geometry 1930 shows the same skirt fitted using the radial search techniques discussed in the present dislcosure and results in a better geometry without crossover. FIG. 19 also illustrates a corresponding geometry with crossover 1920 and a corresponding linear deformer geometry 1930. This example illustrates that the linear deformer geometry 1930 constructed using techniques discussed in the present disclosure is a better geometry than geometry with crossover 1920 when modeling a skirt with a seam in that it avoids modeling defects that might otherwise occur.

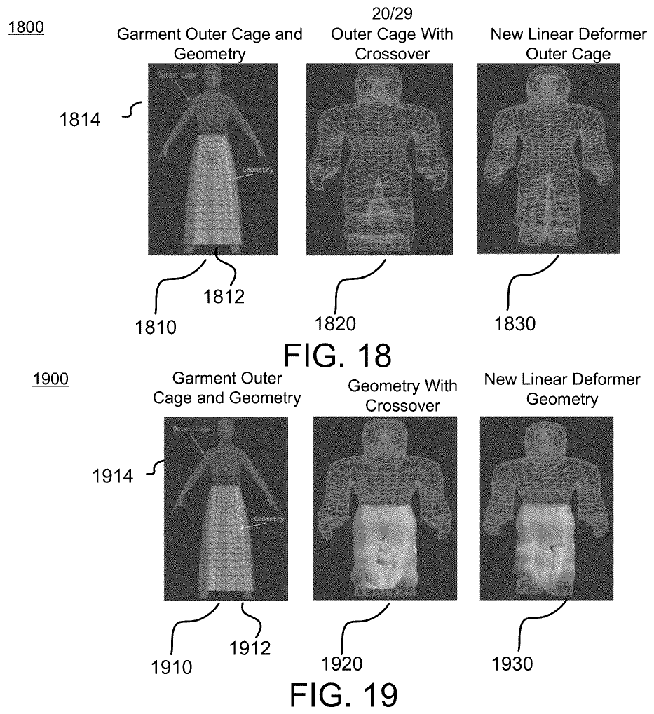

### FIG. 20—Providing Avatar and Layering Garment onto Avatar

FIG. 20 illustrates a flowchart of an example computer-implemented method 2000 to provide a three-dimensional (3D) avatar and layer a garment onto an associated avatar body, in accordance with some implementations. Method 2000 may begin at block 2002.

At block 2002, a three-dimensional (3D) avatar is provided. For example, the 3D avatar may be provided in a 3D virtual environment. The 3D avatar may have an avatar body to be layered with the garment.

The garment may have a source cage defined by an inner cage of the garment (which may also be referred to as a source inner cage), the garment may have a source outer cage defined by an outer cage of the garment, and the avatar body may have a destination cage defined by the outer cage of the avatar body (which may also be referred to as a target inner cage). These three cages may be used as input to the layering, which may yield, as an output cage, a target outer cage.

The 3D avatar is not limited to being provided in a 3D virtual experience or a 3D virtual environment. For example, the 3D avatar may be provided in a studio (e.g., an environment to model assets for a 3D virtual environment) or a store setting (e.g., an environment to sell and/or distribute assets for a 3D virtual environment) or in any application in which 3D avatars are provided. The techniques described herein are broadly applicable on layering clothing onto an avatar body, in any context in which 3D avatars are used. In some implementations, the avatar may be in a virtual environment. Block 2002 may be followed by block 2004.

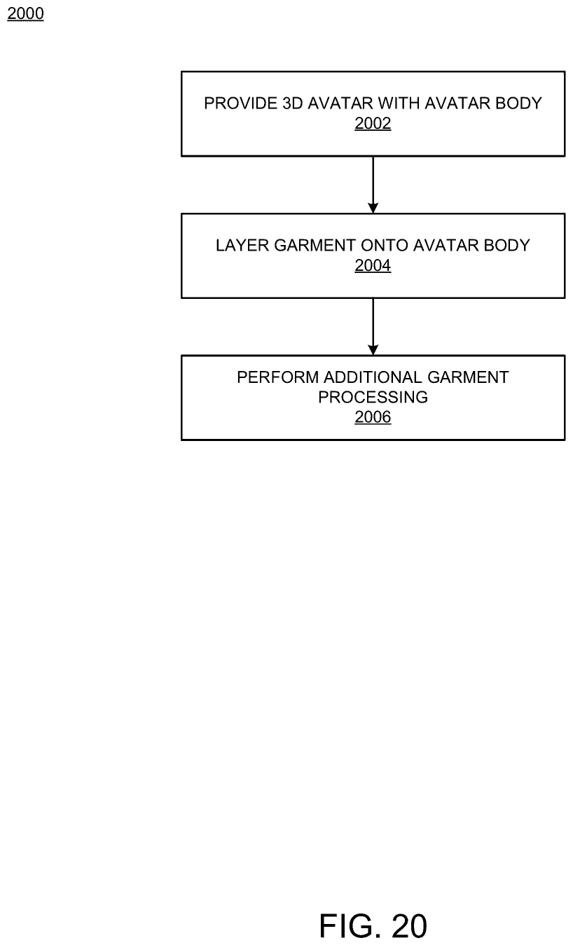

At block 2004, a garment is layered onto the avatar body. Details of example layering techniques are presented in FIG. 21. For layering, as noted above, an inner cage of the garment defines a source cage, an outer cage of the garment defines a source outer cage, and an outer cage of the avatar body defines a destination cage. Block 2004 may be followed by block 2006.

At block 2006, additional processing on the garment may be performed (after the garment has been layered onto the avatar body). For example, in layered clothing, if a stack of cages are used where the cages do not penetrate each other and have space between layers, the clothing geometry may still have issues with respect to modeling boundaries. For example, radial basis function (RBF) techniques and other smooth interpolation techniques can create extrapolation artifacts between cage points when fitting a cage (for a garment) to an avatar body or to an earlier layer of garment. The extrapolation artifacts can cause geometry to penetrate cages and one or more subsequent layers. Using additional cage points for RBF interpolation (which can reduce artifacts) is prohibitively computationally expensive.

When using cages to deform clothing geometry, cage penetrations are caused when there is too much space between cage geometries to support the clothing geometry. To deal with this issue, various additional processing on the garment may be performed.

In some implementations, such processing may include upsampling cages and/or subdividing cages after cage deformation. In some implementations, a fast interpolator is used to deform the clothing geometry. One example of a fast interpolator is a nearest neighbor interpolator, but other interpolators may be used.

In some cases, using a nearest neighbor interpolator without subdivision of cages may generate sharp edges. In such cases, the deformed geometry may not maintain the curve of an original geometry. In some implementations, the cages are subdivided (with optional smoothing) to ensure that the deformed geometry maintains the curvature. These techniques work even if the original cage is flat.

For example, using RBF techniques (e.g., using an inner cage without the outer cage) may cause issues with the clothing geometry. Using both cages can provide better results but is too slow and/or computationally expensive. In various implementations, using cage subdivisions (such as four subdivisions) and/or nearest neighbor interpolation, based on the inner cage without the outer cage, provides better results in terms of eliminating or reducing issues with the clothing geometry while enabling cages to be used with lower usage of computational resources. In various implementations, one or more of cage upsampling, cage subdivision, and/or interpolation are performed to provide accurate layering of clothing on an avatar body.

### FIG. 21—Layering Garment onto Avatar

FIG. 21 illustrates a flowchart of an example computer-implemented method 2100 to layer a garment onto an avatar body, in accordance with some implementations. Method 2100 may begin at block 2102.

At block 2102, a bulk scale is computed. For example, the bulk scale may be computed using the bounding boxes of the garment and avatar cages. The bulk scale computed may be the bulk scale of the overall deformation transformation. In some cases, a bounding box of the garment may be based on an outer cage of the garment and a bounding box of the avatar may be based on an outer cage of the avatar body.

In various implementations, a bulk scale bounding box transformation refers to the process of simultaneously resizing or scaling a large set of bounding boxes proportionally to a new size, such as by applying a scaling factor to the coordinates of each bounding box based on the change in image dimensions. In some implementations, using such a transformation can ensure that the relative positions of objects within the image remain consistent after the scaling operation. Block 2102 pertains to identifying a scaling factor between the bounding boxes. Block 2102 may be followed by block 2104.

At block 2104, influence lists are constructed. The influence lists establish relationships between points on the source cage and the destination cage with points on the source outer cage, relating the inner cage of the garment and the outer cage of the avatar body to points on the garment outer cage. The influence lists pertain to points on the source outer cage and define points on the source cage and points on the destination cage that are influenced by the points on the source outer cage.

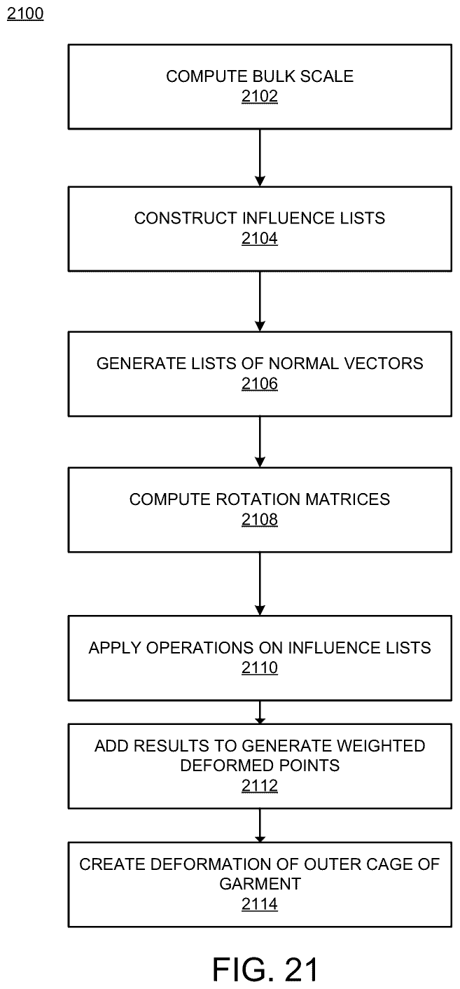

A data structure, such as a K-Dimensional (k-d) tree is formed based on the source outer cage. For each point on the source cage, the point is compared to the k-d tree and corresponding weights computed and normalized. Once the weights are computed, the computed weights can be compiled into a list of influence lists. For example, the list of influence lists may include individual influence lists corresponding to points on the source cage. Additional details of constructing influence lists are described with reference FIG. 22. Block 2104 may be followed by block 2106.

At block 2106, lists of normal vectors are generated. In some implementations, generating such normal vectors may include generating first normal vectors for faces on the source cage adjacent to points corresponding to the faces and second normal vectors for faces on the destination cage adjacent to points corresponding to the faces. Block 2106 may be followed by block 2108.

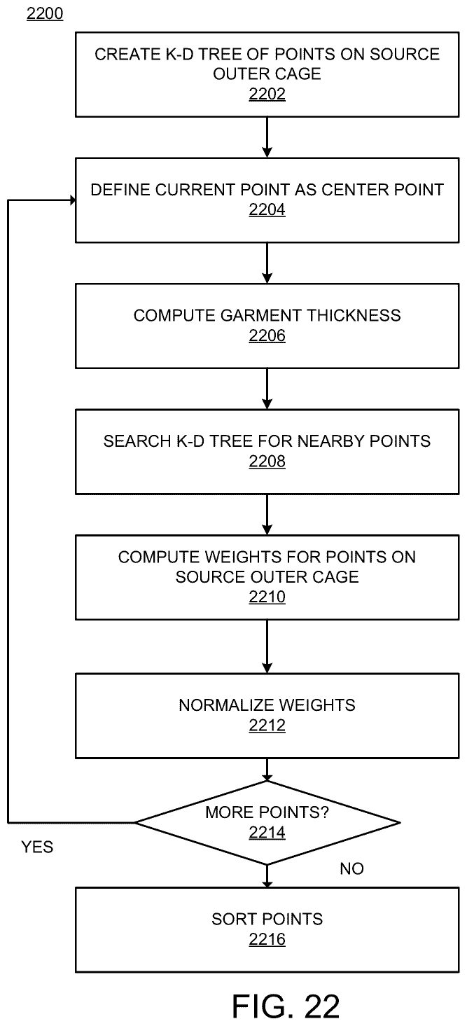

At block 2108, rotation matrices are computed. In some implementations, the rotation matrices are computed by using points on the source cage and corresponding points on the destination cage using the first and second normal vectors. Additional details of computing rotation matrices are described with reference to FIG. 23. Block 2108 may be followed by block 2110.

At block 2110, operations may be applied to the influence lists. In some implementations, the operations may include, for each point in the influence lists, applying corresponding rotation matrices and the bulk scale of the overall deformation transformation to offset vectors between the points on the source cage and the corresponding points on the source outer cage. Block 2110 may be followed by block 2112.

At block 2112, the results of the applying may be added to generate weighted deformed points. In some implementations, vectors corresponding to the points are summed, resulting in weighted deformed points representing overall aspects of the deformation to apply to the points on the source outer cage to deform the garment outer cage. Block 2112 may be followed by block 2114.

At block 2114, a deformation of an outer cage of a garment is created. In some implementations, for points on the source outer cage, coordinates may be found associated with a sum of the weighted deformed points and the coordinates may be assigned to the corresponding points in the source outer cage. This process can create the deformation of the outer cage of the garment, wherein after the deformation of the outer cage, the garment is usable to fit the garment onto the avatar body.

### FIG. 22—Constructing Influence Lists

FIG. 22 illustrates a flowchart of an example computer-implemented method 2200 to construct influence lists, in accordance with some implementations. Method 2200 may begin at block 2202.

At block 2202, a K-dimensional tree (k-d tree) of points of the source outer cage is created. The k-d tree is a space-partitioning data structure for organizing points in a K-dimensional space and is usable to perform searches involving a multidimensional search key (such as nearest neighbor searches). Block 2202 may be followed by block 2204.

At block 2204, a current point is defined as a center point. In some implementations, when creating the influence lists, it may be appropriate to process each point on the source cage and each point on the destination cage separately. When processing a given point on the source cage or a given point on the destination cage, the point is referred to as a center point. Block 2204 may be followed by block 2206.

At block 2206, a garment thickness is computed. Specifically, in some implementations, the thickness of the garment may be computed as the length of the vector from the center point (on the source cage or the destination cage). Such a length is found as the magnitude of the vector (which may be calculated as the square root of the sum of its components). Block 2206 may be followed by block 2208.

At block 2208, the k-d tree is searched for nearby points. The k-d tree is searched for nearby points within a radius that is selected based on the thickness, e.g., is proportional to the thickness. Thus, the thicker the garment is, the farther the search searches on the k-d tree to identify points influencing the center point. Block 2208 may be followed by block 2210.

At block 2210, weights for points on the source outer cage are computed. In some implementations, the weight of a point is assigned based on its proximity to the center point. The weight of an influence point has an inverse relationship with distance to the center point. Block 2210 may be followed by block 2212.

At block 2212, the weights are normalized. The normalizing is optional. In some implementations, the weights may be used without normalizing. In some implementations, normalizing may be performed by modifying the weights so that they sum to 1. Block 2212 may be followed by block 2214.

At block 2214, it is determined if there are more points to process. The processing may provide a round of processing for each point on the source cage and each point on the destination cage. In this manner, the points on these cages that are influenced by points on the source outer cage are established. If there are more points, block 2214 is followed by block 2204. In block 2204, the next point is considered as the center point for processing. If not, block 2214 is followed by block 2216, in that there are no further points to process.

At block 2216, the results of processing the points are sorted and organized for use as influence lists. In some implementations, the sorting includes sorting the points on the source outer cage and the corresponding normalized computed weights into a list of influence lists. Such a list of influence lists may be constructed such that a point on the source outer cage having an index i in the list of influence lists corresponds to an influence list containing the points on the source cage, the destination cage, or a combination thereof influenced by the point on the source outer cage having the index i.

In various implementations, influence lists provide information about the effects of each point on the source outer cage on corresponding points on the source cage and the destination cage. The influence lists specify the points that affect other points and the degree of effect. This information is used in various implementations to provide high-quality deformation, improving the results of the linear deformation (compared to when linear deformation is performed without the use of influence lists).

### FIG. 23—Computing Rotation Matrices

FIG. 23 illustrates a flowchart of an example computer-implemented method 2300 to compute rotation matrices, in accordance with some implementations. Method 2300 may begin at block 2302.

At block 2302, vectors in the lists of normal vectors may be normalized. This normalization is optional and other preprocessing of the vectors may be performed, as appropriate in various implementations. In some implementations, normalizing a vector includes scaling the vector so that its magnitude is one unit. Block 2302 may be followed by block 2304.

At block 2304, initial matrices are computed. In some implementations, the initial matrices are computed using outer products of the vectors for the points on the source cage and the corresponding vectors for the points on the destination cages. An outer product of two vectors is a mathematical operation that generates a matrix where each element is the product of the corresponding elements from the two input vectors. Computing an outer product creates a matrix that represents the relationships between the two vectors by multiplying each component of one vector with each component of the other vector, resulting in a larger matrix with dimensions based on the sizes of the original vectors. Block 2304 may be followed by block 2306.

At block 2306, singular value decompositions (SVDs) of the initial matrices are computed. The Singular Value Decomposition (SVD) of a matrix is a factorization of that matrix into three matrices.

The SVD of an m×n matrix A with real values is a factorization of A as UEVT, where U is an m×m orthogonal matrix, Vis an n×n orthogonal matrix, and Σ is a diagonal matrix with nonnegative real entries on the diagonal. In particular, the SVDs of the initial matrices are used to generate U matrices and transposed V matrices. Block 2306 may be followed by block 2308.

At block 2308, rotation matrices are generated. In some implementations, the rotation matrices are computed using the U matrices and the transposed V matrices from the SVD information found at block 2306. By combining these matrices, successive rotations define transformations between an initial coordinate system and a final coordinate system. Specifically, in some implementations, the rotation matrices are used to transform points in a garment coordinate system to corresponding points in an avatar coordinate system. The Σ matrix represents scaling and is not applicable to the transformation.

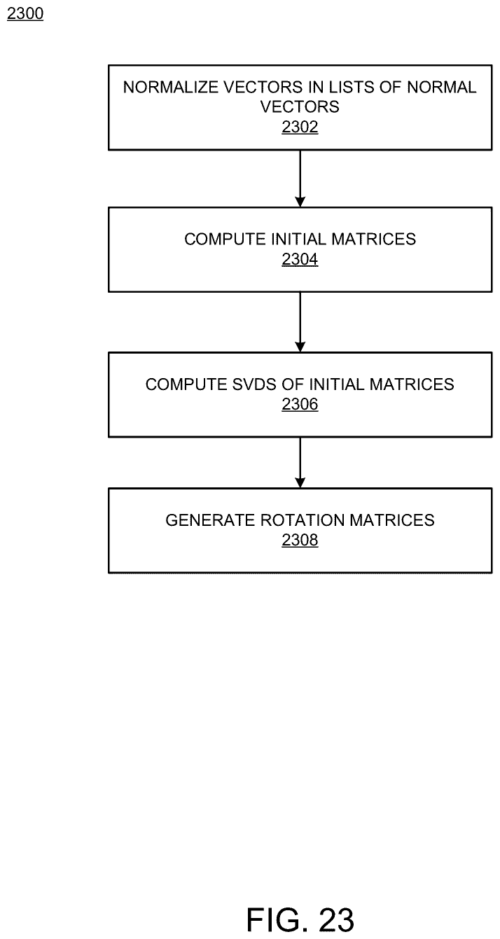

### FIG. 24—Iterating Through Influence List

FIG. 24 illustrates a flowchart of an example computer-implemented method 2400 to process points in an influence list, in accordance with some implementations. Method 2400 may begin at block 2402.

At block 2402, a center point is defined as a point of a source outer cage. For example, in some implementations, each point of the source outer cage is used as a center point to determine the effects of the influence information associated with the point of the source outer cage. Block 2402 may be followed by block 2404.

At block 2404, a point on the source cage influenced by the center point is identified. For example, such a point may be obtained from the influence list corresponding to the center point. Block 2404 may be followed by block 2406.

At block 2406, a corresponding point on the source outer cage is obtained. The corresponding point may be obtained using the influence list. Block 2406 may be followed by block 2408.

At block 2408, an offset vector is computed. In some implementations, the offset vector is found as a vector between the source cage and the source outer cage at the corresponding points, as identified in block 2404 and block 2406. Source cage vertices and source outer cage vertices are used to find an offset vector. For example, an offset vector may be a vector determined as a vector originating at a vertex of the source cage that connects that vertex to a corresponding vertex on the source outer cage. Block 2408 may be followed by block 2410.

At block 2410, a rotation and a bulk scale are applied to the offset vector to generate a new vector. In some implementations, the rotation is based on a rotation matrix, generated as described above with reference to FIG. 23. Such a rotation matrix transforms the point from the garment coordinate system to the avatar coordinate system. The bulk scale may be a bulk scale for the overall transformation. Performing these rotations and scaling adapt the offset vector for use in the overall deformation. Block 2410 may be followed by block 2412.

At block 2412, the new vector is added to a point on the destination cage to generate a modified point and a weight is applied to the modified point to generate a weighted deformed point. In some implementations, the corresponding point on the destination cage is shifted in the direction of the new vector, where the new vector is a vector generated as discussed in block 2410.

In some cases, this shift is modified because the shift is also affected by the corresponding weight, where the weight is obtained from the influence list. In some implementations, multiple vectors may be generated by considering the various weights. The generated vectors, when combined, indicate the modifications to the source outer cage. Block 2412 may be followed by block 2414.

At block 2414, the weighted deformed point is added to a vertex map. In some implementations, the vertex map is a vertex map corresponding to the point on the source outer cage that the weighted deformed point is a deformation of. By populating such a vertex map, the weighted deformed points are consolidated in one place, to provide unified information for modeling the deformation. Block 2414 may be followed by block 2416.

At block 2416, it is determined if there are more points to process. In some implementations, the determination is based on whether the points included in the source outer cage have been fully considered. Such consideration is necessary to fully utilize the entire source outer cage so that the source outer cage may be transformed so as to adequately transform the source outer cage as a whole. If so, block 2416 is followed by block 2404 to consider additional points. If not, block 2416 is followed by block 2418.

At block 2418, the weighted points in the vertex map are totaled. By finding the total of the weight points in the vertex map, the vectors associated with each point may be combined and their contributions may be combined together to determine how to deform the source outer cage. In some implementations, for each vertex in the source outer cage, the totaling is followed by obtaining the calculated sum of weighted points and assigning those coordinates to the vertex to create the deformation.

Using the techniques described herein for cage deformation, it may be possible to reduce or eliminate issues such as the crossover in the central seam of skirts and dresses when deforming cages to fit a geometry, e.g., of an avatar body. For example, in the case of a garment that is a skirt to be layered over an avatar body, the techniques described herein utilize overlapping points on the seam as influences on each other such that they end up in the same (or similar/close to) position in the deformed cage. Hence, the techniques provided herein, when applied, provide an effective way to layer garments such as skirts and dresses onto avatars, by modeling central seams of such garments with accuracy.

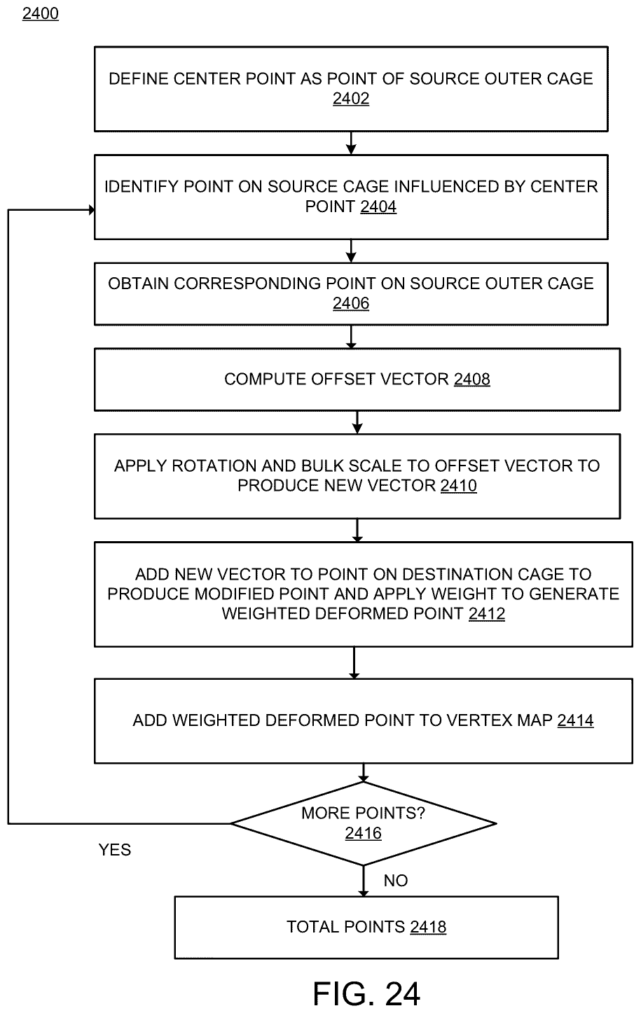

### FIG. 25—Example Levels of Rigidity

FIG. 25 illustrates avatars with layered clothing having an inner layer associated with various levels of rigidity, in accordance with some implementations. For example, FIG. 25 illustrates an avatar wearing a t-shirt with low rigidity 2510, an avatar wearing a t-shirt with a default (i.e., moderate) rigidity 2512, and an avatar wearing a t-shirt with high rigidity 2514.

Alternative layered clothing systems provide two parameters to a creator of a piece of clothing as properties associated with the clothing-puffiness and shrink factor. Both parameters relate to the size or thickness of a piece of clothing and control how tightly pieces of clothing fit the body, but do slightly different things. The parameters may be exposed to creators, e.g., creators that create clothing or other items that can be layered on an avatar body; that generate avatar outfits that combine two or more clothing or other items to be layered on an avatar body; that create avatar bodies; etc. The effect of these parameters on how items are layered on an avatar body may not be readily understandable by creators.

Implementations presented herein can be used to alleviate two issues. First the technique may solve an effect when soft clothing (e.g., a t-shirt) causes a bulge under other clothing. Some implementations may allow soft clothes to be compressed under subsequent layers. However, in order to do this compression, it is important to ensure the outermost layer has the right puffiness parameter, which may be difficult to achieve in mix-and-match outfits.

Various implementations described herein address several problems. First, the present techniques make the creator controls (parameters whose values can be set by creators) for clothing bulk easy-to use and intuitive, and easily explainable to a creator. The implementations enable easy explanation of the effect of the parameters, making their use easy and intuitive. Second, the implementations introduce effective defaults (default values of parameters that control how clothing/accessories/items are layered onto an avatar body and onto other items), that, with no developer interaction or input, solve some of the fitting issues mentioned above (e.g., a bulge caused by soft clothing layered under other clothing).

Various implementations described herein are backward compatible, since they retain the original functionality of the alternative puffiness and shrink factor parameters while replacing them with more effective layering of clothing. In some implementations, the combined puffiness and shrink factor parameters are replaced with a rigidity parameter. Rigidity controls the extent to which a piece of clothing (or other item to be layered) resists compression, and the extent to which a piece of clothing (or other item to be layered) can compress other clothing (or other items) below it in the layering.

In some implementations, the rigidity parameter may be set to a default that is not full puffiness, i.e., permits some compression of fabric. There may also be a second (non-user facing) parameter outer layer weight that controls the extent to which an outer layer can compress an inner layer, when items associated with each layer have different rigidity values that control such compression. This weighting (based on the outer layer weight parameter) allows the outer layers to have more influence over the silhouette of the avatar after the clothing or item is layered over it.

In some implementations, rigidity is the factor by which a piece of clothing maintains its shape in a stack of clothing (e.g., the piece of clothing is part of a stack with one or more other layers of clothing, accessories, or other items). For example, rigidity may be expressed as a real number between 0 and 1. For instance, a cotton shirt may have a low rigidity (e.g., a rigidity of 0.1 to 0.2) while a suit of armor has no squishablity (e.g., a rigidity of 1.0). A leather jacket or frilly dress may have a value somewhere in the middle (e.g., a rigidity of 0.5 to 0.7).

An item with a higher rigidity tends to force items with lower rigidity that are under the higher-rigidity item to compress so that the high-rigidity item can maintain its own shape. Furthermore, when items with lower rigidity are layered on top of a high-rigidity item, items with high rigidity resist compression.

In some implementations, the second parameter outer layer weight is global to the outfit (applies across two or more layers) and not the individual clothing or other item. In practice, this outer layer weight may be set as a flag. In some implementations, the parameter is not user-facing. The outer layer weight parameter controls the bias between the outer and inner layers (the weight controls the extent to which the rigidity of an outer layer that compresses an inner layer is prioritized over the extent to which the rigidity of an inner layer that resists such compression).

For instance, an outer layer weight of 1 means that the inner layers are completely compressed regardless of their actual rigidity values, and an outer layer weight of 0 means the outer layer does not compress the inner layers. In some implementations, the value of outer layer weight is set to be about 0.6-0.8, where the outer layer has more influence but still respects the resistance to compression offered by the inner layers based on their rigidity parameter.

As seen in FIG. 25, the low rigidity value of 0.1 of the black t-shirt of the avatar 2510 causes the outer jacket to compress substantially, providing a snug fit of the jacket (e.g., the shoulders and the pockets of the jacket are flush against the avatar body). A default, higher rigidity (e.g., 0.6) causes the t-shirt of avatar 2520 to resist compression, providing a more relaxed fit of the jacket (e.g., the shoulders and pockets are a bit far from the avatar body since the t-shirt with the higher rigidity value resists compression). A high rigidity value of 1 causes the t-shirt of avatar 2530 to fully resist compression (maintain the original shape of the t-shirt), providing a baggy/puffy fit of the jacket (e.g., the entire jacket is loosely fit over the avatar body since the t-shirt resists any compression).

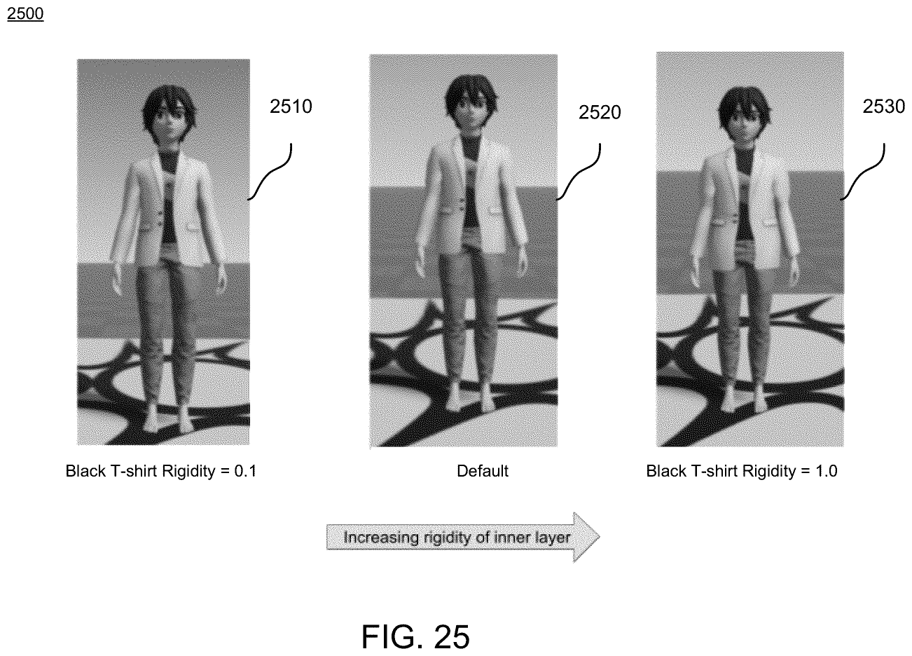

### FIG. 26—Example Garments with Rigidity

FIG. 26 illustrates three example garments, each including an inner cage and an outer cage, each associated with a rigidity value 2600, in accordance with some implementations. For example, there may be armor 2610 having a rigidity value of 1.0 with a corresponding shared inner cage 2612, a sweater 2620 having a rigidity value of 0.1 with a corresponding shared inner cage 2622, and a jacket 2630 having a rigidity value of 0.3 with a corresponding shared inner cage 2632.

In some implementations, interactions between layers are modeled just considering two layers at a time and their respective rigidity parameters. In some implementations, the interactions between the two layers are satisfied, e.g., if each garment has a single rigidity parameter (no mixed rigidity with different values for the garment exerting/resisting compressions). In various implementations, a tailored shape of each cage is first obtained.

In some implementations, a tailored shape is the shape of the garment if applied directly to the avatar body, with no layers in between. The new shape of a garment is then inferred based on effects of it being layered with another garment.

Note that because the tailored garments have been fitted directly to the body, the tailored garments have the same inner cage, and the outer cages are referred to specifically in the below process. The operations serve to determine the outer shape of the whole clothing stack based on using tailored shapes. Once this result is obtained, the outer shape can then be used to compress the outer layer and the subsequent ones inward.

For instance, take the armor 2610, the sweater 2620, and the jacket 2630, each having the shared inner cage and different outer cages. There may be a number of possible cases.

In case #1, a highest rigidity garment is layered (e.g., armor 2610) over a lowest rigidity garment (e.g., sweater 2620). In such a case, the highest rigidity garment reshapes the low-rigidity garment such that it appears that the low-rigidity garment does not exist.

In case #2, a lowest rigidity garment (e.g., sweater 2620) is layered over a highest rigidity garment (e.g., armor 2610). In such a case, the high rigidity garment reshapes the inner cage of the outer layer to be the same as the high rigidity garment, as if the outer layer is now tailored to the high rigidity garment. The new shape is the second garment fitted over the first garment as if the first garment were a body.

In case #3, a higher rigidity garment (e.g., jacket 2630) is layered over a lower rigidity garment (e.g., sweater 2610). In such a case, the new shape is equivalent to a weighted average of the tailored inner cage of the outer garment with the tailored outer cage of the inner garment, and then doing the fitting of the outer garment onto the new inner cage. In this case, the new outer silhouette more closely resembles the tailored silhouette of the garment having a higher rigidity.

In case #4, a lower rigidity garment (e.g., sweater 2610) is layered over a higher rigidity garment (e.g., jacket 2630). In such a case, the new shape is equivalent to a weighted average of the tailored inner cage of the outer garment with the tailored outer cage of the inner garment, and then doing the fitting of the outer garment onto the new inner cage. In this case, the new outer silhouette more closely resembles the tailored silhouette of the garment having a higher rigidity.

In case #5, there is equal rigidity for both garments (e.g., two jackets 2630). In such a case, the inner cage of the outer garment and the tailored outer cage of the inner garment are averaged and the outer garment is fitted onto this new inner cage.

In cases 3, 4, and 5, the averages are weighted by the Outer Layer Weight Wₒₗ) parameter, where for each cage vertex, the resulting weighted inner cage vertex Cⁱᵣₑₛ is

$${{C}^{i}}_{res} = ( {W}_{A} ) {{A}^{i}}_{outer} ) + ( {W}_{B} ) {{B}^{i}}_{inner}$$

$${{R}_{A}}^{i} = {{r}_{A}}^{i} ( 1 - {W}_{ol} )$$

$${{R}_{B}}^{i} = {{r}_{B}}^{i} {W}_{ol}$$

$${W}_{A} = {{R}_{A}}^{i} / ( {{R}^{i}}_{A} + {{R}^{i}}_{B} )$$

$${W}_{B} = {{R}_{B}}^{i} / ( {{R}^{i}}_{A} + {{R}^{i}}_{B} )$$

Here, Aⁱₒᵤₜₑᵣ is the i^{th} tailored outer cage vertex of the inner garment, and Bⁱᵢₙₙₑᵣ is the i^{th} tailored inner cage vertex of the outer garment (which may be equivalent to the outer cage of the body), and r is the respective rigidity parameter. R is a reweighted rigidity after application of Wₒₗ.

Note that using Wₒₗ as specified here provides a weighted average. If Wₒₗ is 0.5, because the weights are renormalized, no adjustment is made. Setting Wₒₗ to 1 reduces the effective rigidity of the inner layer effective rigidity to 0 and setting Wₒₗ to 0 reduces the effective rigidity of the outer layer to 0.

Once the C vertices are computed (i.e., the vertices for the resulting weighted inner cage), it becomes possible to treat C as the new weighted outer cage of A, and layer garment B on top of it.

After combining the two garments, the new combined garment has the same tailored inner cage as the original garments, but with a new outer cage that may be thicker than either of the individual garments. For each vertex on the new outer cage, the vertex is assigned a rigidity that is computed as such. If the outer garment had a higher rigidity, that rigidity is used. If the inner garment had a higher rigidity, the new rigidity is computed based on the two rigidities, e.g., as a weighted average of the two.

Computing the rigidity in this manner ensures that if the outer garment was the one that was not rigid, then this new combined garment has some give—but only up until that layer deforms. But if the outer garment was rigidity, the outer garment may have already compressed the inner garment as much as garment is capable of. Such an approach models the outer garment as having compressed the undergarments until they have the same spring constant as the outer garment. The techniques presented herein express that logic. The techniques may express a rough approximation of the logic.

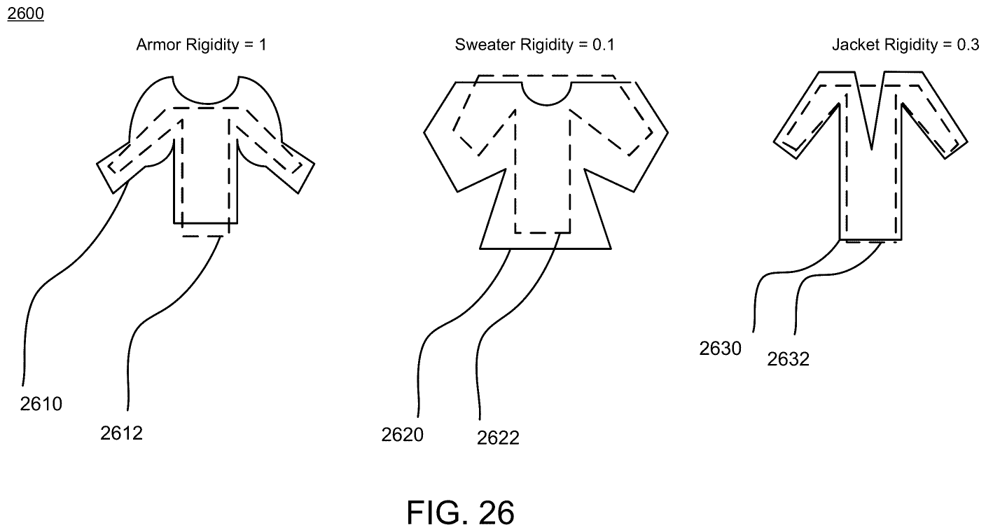

### FIG. 27—Passes of Garment Layering

FIG. 27 illustrates two passes in which garments are layered on top of one another 2700, in accordance with some implementations. In pass 1, there are three pieces of clothing. Each piece of clothing is associated with a rigidity value used to generate a thickness/offset vector, including thickness/offset vector 2712, thickness/offset vector 2714, and thickness/offset vector 2716.

In pass 1, the layers are expanded as usual, assuming no compression. That is, the layers are just put on top of each other. In pass 1, each of the thickness/offset vectors is associated with the offset produced by the linear deformer. That is, thickness/offset vector 2712, thickness/offset vector 2714, and thickness/offset vector 2716 are each the original length as defined by the clothing item.

Accordingly, each thickness/offset vector corresponds to an offset vector of the same length. Accordingly, each cage mesh is separated by the same offset. For example, in pass 1, cage mesh 2722 is positioned based on thickness/offset vector 2712. Cage mesh 2724 is positioned based on thickness/offset vector 2714. Cage mesh 2726, which is the resultant estimated outer cage in the first pass, is positioned based on thickness/offset vector 2716.

In pass 2, the layers are expanded using the compression techniques described in this disclosure, layer by layer. At each layer, the resulting cage is different than in pass 1, as it could be compressed further inwards when a layer is added on top of it. This means the corresponding thickness/offset vectors could be shorter.

Accordingly, the final cage may be determined using the techniques described in the discussion of FIG. 26.

After the two passes, the cage mesh 2746 is accessed and used as the compression target for the cage mesh 2726 determined in the first pass 2710 (i.e., apply compression as is done now outwards-in. This does mean that the clothing under the final cage may not match the positions shown in thickness/offset vector 2732, thickness/offset vector 2734, and thickness/offset vector 2736, but this approach may reduce potential layer penetration for low-rigidity clothing.

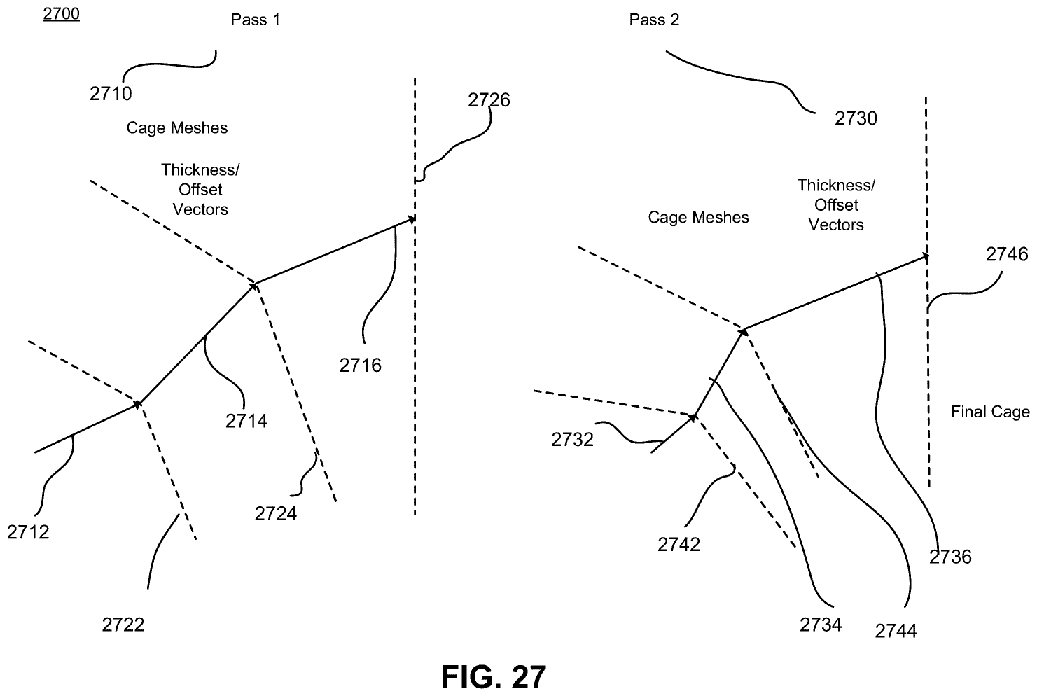

### FIG. 28—Layering Garments onto Avatar Body

FIG. 28 illustrates a flowchart of an example computer-implemented method 2800 to layer garments onto an avatar body, in accordance with some implementations. Method 2800 may begin at block 2802.

At block 2802, a three-dimensional (3D) avatar is provided. For example, the 3D avatar may be provided in a 3D virtual environment. The 3D avatar may have an avatar body to be layered with the garment.

However, the 3D avatar is not limited to being provided in a 3D virtual experience or a 3D virtual environment. For example, the 3D avatar may be provided in a studio or a store setting. The techniques described herein may be more broadly readable on layering clothing onto an avatar body, without the avatar necessarily having to be in a virtual environment. Block 2802 may be followed by block 2804.

At block 2804, garments are layered onto the avatar body to generate an estimated outer cage. The estimated outer cage is generated by layering a plurality of garments onto an avatar body of the 3D avatar in a specific order, wherein each garment has a respective rigidity, inner cage, and outer cage, and wherein the plurality of garments together form an outfit, wherein the outfit is optionally associated with an outer layer weight. Block 2804 may be followed by block 2806.

At block 2806, garments are layered onto the avatar body with compression to generate an estimated target outer cage. The target outer cage may be generated by layering the plurality of garments onto the avatar body in the specific order with compression, wherein the layering comprises adding a first outer garment being layered based on the rigidity of the first outer garment and the outer layer weight (when available/used) of the outfit.

However, the layering with compression is not limited to layering a single outer garment onto an inner garment. In some implementations, layering the plurality of garments onto the avatar with compression may further include, after adding the first outer garment over the inner garment, layering a second outer garment over the first outer garment based on the rigidity of the second outer garment and the outer layer weight of the outfit. Block 2806 may be followed by block 2808.

At block 2808, compression is applied to an estimated outer cage based on a target outer cage to generate a final outer cage. In some implementations, applying compression to the estimated outer cage is performed by using the target outer cage as a compression target to generate a final outer cage.

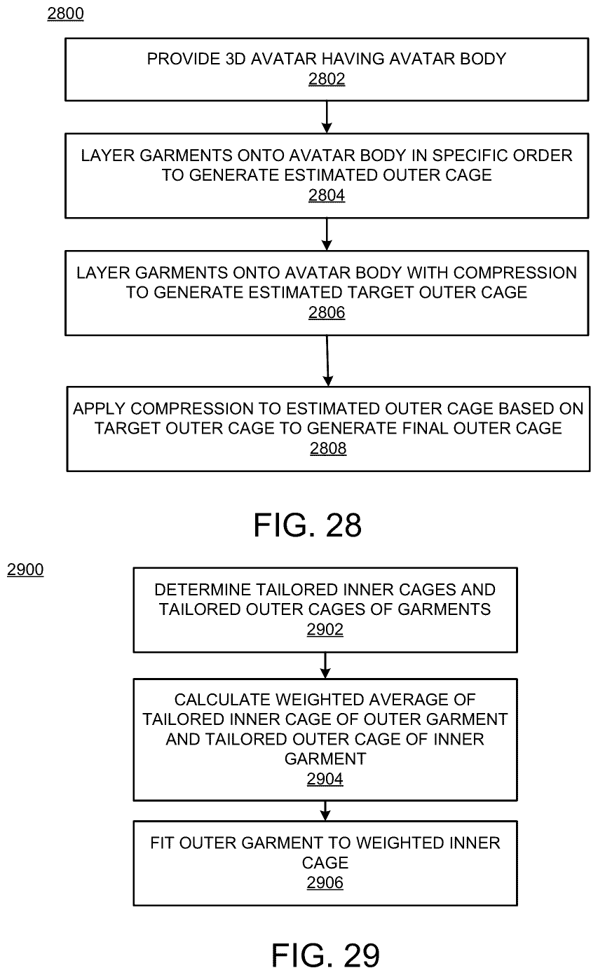

### FIG. 29—Layering Outer Garment onto Inner Garment

FIG. 29 illustrates a flowchart of an example computer-implemented method 2900 to layer an outer garment onto an inner garment, in accordance with some implementations. Method 2900 may begin at block 2902.

At block 2902, tailored inner cages and tailored outer cages of garments are determined. For example, a tailored cage is defined as the shape of the garment if applied directly to the body, with no layers underneath. Note that because tailored garments are fitted directly to the avatar body, the tailored garments have the same inner cage. Block 2902 may be followed by block 2904.

At block 2904, a weighted average of the tailored inner cage of the outer garment and the tailored outer cage of an inner garment may be calculated. In some implementations, such a weighted average may be used to determine a weighted inner cage. Specific formulas used to calculate such a weighted inner cage based on such a weighted average are presented above. Block 2904 may be followed by block 2906.

At block 2906, the outer garment is fit to the weighted inner cage.

Various implementations described herein provide ways to control clothing rigidity and bulkiness when layers of clothing (or other items) are applied on an avatar body. The techniques make parameters presented to developers easy to understand and enable default values for such parameters that overcome problems that occur with alternative ways of managing rigidity, such as when soft clothing produces bulges under other clothing.

The described implementations provide parameters for garments, including a rigidity for individual garments and a global outer layer weight variable. With the use of these parameters, automatically layering successive clothing layers with differing rigidity is easier, computationally efficient, and provides a more realistic/accurate view of the avatar body with garments layered thereon.

What is claimed is:

1. A computer-implemented method to create a deformation of an outer cage of a garment to fit an avatar body of a three-dimensional (3D) avatar, the method comprising:
layering the garment onto the avatar body, wherein an inner cage of the garment defines a source cage, an outer cage of the garment defines a source outer cage, and an outer cage of the avatar body defines a destination cage, wherein the layering includes:
computing a bulk scale of an overall deformation transformation using a bounding box of the outer cage of the garment and a bounding box of the outer cage of the avatar body;
constructing influence lists for points on the source outer cage, wherein the influence lists define points on the source cage and points on the destination cage influenced by the points on the source outer cage;
generating first normal vectors for faces on the source cage adjacent to corresponding points and second normal vectors for faces on the destination cage adjacent to corresponding points;
computing rotation matrices for the points on the source cage and corresponding points on the destination cage using the first and second normal vectors;
for each point in the influence lists, applying corresponding rotation matrices and the bulk scale of the overall deformation transformation to offset vectors between the points on the source cage and the corresponding points on the source outer cage;
adding results of the applying to corresponding points on the destination cage to generate weighted deformed points; and
for points on the source outer cage, finding coordinates associated with a sum of the weighted deformed points and assigning the coordinates to the corresponding points in the source outer cage to create the deformation of the outer cage of the garment, wherein the deformation of the outer cage of the garment is usable to fit the garment onto the avatar body.

2. The computer-implemented method of claim 1, wherein constructing influence lists for the points on the source outer cage comprises:
creating a k-dimensional tree (K-D tree) of points on the source outer cage; and
for points on the source cage and for points on the destination cage:
defining a center point as a current point on the source cage or the destination cage;
searching the K-D tree for nearby points on the source outer cage within a radius of the center point proportional to a thickness of the garment; and
computing weights for points on the source outer cage within the radius of the center point; and
sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

3. The computer-implemented method of claim 2, further comprising computing the thickness of the garment as a length of a vector from the center point to a corresponding point on the source outer cage.

4. The computer-implemented method of claim 2, further comprising normalizing the computed weights for the points.

5. The computer-implemented method of claim 1, wherein computing rotation matrices for points on the source cage and corresponding points on the destination cage comprises:
computing initial matrices using outer products of the vectors for the points on the source cage and the corresponding vectors for the points on the destination cage;
computing singular value decompositions (SVDs) of the initial matrices to generate U matrices and transposed V matrices; and
computing the rotation matrices using the U matrices and the transposed V matrices,
wherein the rotation matrices transform points in a garment coordinate system to corresponding points in an avatar coordinate system.

6. The computer-implemented method of claim 1, wherein applying, for each point in the influence lists, comprises:
for points on the source outer cage:
defining a center point as a point of the source outer cage being iterated on;
for points on the source cage that are influenced by the center point:
obtaining the corresponding point on the source outer cage;
computing an offset vector between the source cage at the point influenced by the center point and the source outer cage at the corresponding point;
applying the corresponding rotation and the bulk scale to the offset vector to produce a new vector;
obtaining a weighted deformed point based on the new vector and a corresponding weight from the influence lists; and
adding the weighted deformed point to a corresponding vertex map; and
totaling the weighted deformed points in the vertex map to produce the sum of the weighted deformed points.

7. The computer-implemented method of claim 1, further comprising upsampling the outer cage of the garment after creating the deformation of the outer cage of the garment.

8. The computer-implemented method of claim 1, further comprising subdividing the outer cage of the garment.

9. The computer-implemented method of claim 8, further comprising using interpolation on the subdivided outer cage of the garment to produce a higher-quality fit for multiple clothing layers.

10. A non-transitory computer-readable medium with instructions stored thereon that, responsive to execution by a processing device, causes the processing device to perform operations comprising:
layering a garment onto an avatar body of a three-dimensional (3D) avatar, wherein an inner cage of the garment defines a source cage, an outer cage of the garment defines a source outer cage, and an outer cage of the avatar body defines a destination cage, wherein the layering includes:
computing a bulk scale of an overall deformation transformation using a bounding box of the outer cage of the garment and a bounding box of the outer cage of the avatar body;
constructing influence lists for points on the source outer cage, wherein the influence lists define points on the source cage and points on the destination cage influenced by the points on the source outer cage;
generating first normal vectors for faces on the source cage adjacent to corresponding points and second normal vectors for faces on the destination cage adjacent to corresponding points;
computing rotation matrices for the points on the source cage and corresponding points on the destination cage using the first and second normal vectors;
for each point in the influence lists, applying corresponding rotation matrices and the bulk scale of the overall deformation transformation to offset vectors between the points on the source cage and the corresponding points on the source outer cage;
adding results of the applying to corresponding points on the destination cage to generate weighted deformed points; and
for points on the source outer cage, finding coordinates associated with a sum of the weighted deformed points and assigning the coordinates to the corresponding points in the source outer cage to create a deformation of the outer cage of the garment, wherein the deformation of the outer cage of the garment is usable to fit the garment onto the avatar body.

11. The non-transitory computer-readable medium of claim 10, wherein constructing influence lists for the points on the source outer cage comprises:
creating a k-dimensional tree (K-D tree) of points on the source outer cage; and
for points on the source cage and for points on the destination cage:
defining a center point as a current point on the source cage or the destination cage;
searching the K-D tree for nearby points on the source outer cage within a radius of the center point proportional to a thickness of the garment; and
computing weights for points on the source outer cage within the radius of the center point; and
sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

12. The non-transitory computer-readable medium of claim 11, the operations further comprising computing the thickness of the garment as a length of a vector from the center point to a corresponding point on the source outer cage.

13. The non-transitory computer-readable medium of claim 11, the operations further comprising normalizing the computed weights for the points.

14. The non-transitory computer-readable medium of claim 10, wherein computing rotation matrices for points on the source cage and corresponding points on the destination cage comprises:
computing initial matrices using outer products of the vectors for the points on the source cage and the corresponding vectors for the points on the destination cage;
computing singular value decompositions (SVDs) of the initial matrices to generate U matrices and transposed V matrices; and
computing the rotation matrices using the U matrices and the transposed V matrices,
wherein the rotation matrices transform points in a garment coordinate system to corresponding points in an avatar coordinate system.

15. The non-transitory computer-readable medium of claim 10, wherein applying, for each point in the influence lists, comprises:
for points on the source outer cage:
defining a center point as a point of the source outer cage being iterated on;
for points on the source cage that are influenced by the center point:
obtaining the corresponding point on the source outer cage;
computing an offset vector between the source cage at the point influenced by the center point and the source outer cage at the corresponding point;
applying the corresponding rotation and the bulk scale to the offset vector to produce a new vector;
obtaining a weighted deformed point based on the new vector and a corresponding weight from the influence lists; and
adding the weighted deformed point to a corresponding vertex map; and
totaling the weighted deformed points in the vertex map to produce the sum of the weighted deformed points.

16. A system, comprising:
a memory with instructions stored thereon; and
a processing device, coupled to the memory, the processing device configured to access the memory and execute the instructions, wherein the instructions cause the processing device to perform operations comprising:
layering a garment onto an avatar body of a three-dimensional (3D) avatar, wherein an inner cage of the garment defines a source cage, an outer cage of the garment defines a source outer cage, and an outer cage of the avatar body defines a destination cage, wherein the layering includes:
computing a bulk scale of an overall deformation transformation using a bounding box of the outer cage of the garment and a bounding box of the outer cage of the avatar body;
constructing influence lists for points on the source outer cage, wherein the influence lists define points on the source cage and points on the destination cage influenced by the points on the source outer cage;
generating first normal vectors for faces on the source cage adjacent to corresponding points and second normal vectors for faces on the destination cage adjacent to corresponding points;
computing rotation matrices for the points on the source cage and corresponding points on the destination cage using the first and second normal vectors;
for each point in the influence lists, applying corresponding rotation matrices and the bulk scale of the overall deformation transformation to offset vectors between the points on the source cage and the corresponding points on the source outer cage;
adding results of the applying to corresponding points on the destination cage to generate weighted deformed points; and
for points on the source outer cage, finding coordinates associated with a sum of the weighted deformed points and assigning the coordinates to the corresponding points in the source outer cage to create a deformation of the outer cage of the garment, wherein the deformation of the outer cage of the garment is usable to fit the garment onto the avatar body.

17. The system of claim 16, wherein constructing influence lists for the points on the source outer cage comprises:
creating a k-dimensional tree (K-D tree) of points on the source outer cage; and
for points on the source cage and for points on the destination cage:
defining a center point as a current point on the source cage or the destination cage;
searching the K-D tree for nearby points on the source outer cage within a radius of the center point proportional to a thickness of the garment; and
computing weights for points on the source outer cage within the radius of the center point; and
sorting the points on the source outer cage and the corresponding normalized computed weights into a list of influence lists, wherein a point on the source outer cage having an index i in the list of influence lists corresponds to an influence list containing the points on the source cage, the destination cage, or a combination thereof influenced by the point on the source outer cage having the index i.

18. The system of claim 17, the operations further comprising computing the thickness of the garment as a length of a vector from the center point to a corresponding point on the source outer cage.

19. The system of claim 17, wherein computing rotation matrices for points on the source cage and corresponding points on the destination cage comprises:
computing initial matrices using outer products of the vectors for the points on the source cage and the corresponding vectors for the points on the destination cage;
computing singular value decompositions (SVDs) of the initial matrices to generate U matrices and transposed V matrices; and
computing the rotation matrices using the U matrices and the transposed V matrices,
wherein the rotation matrices transform points in a garment coordinate system to corresponding points in an avatar coordinate system.

20. The system of claim 16, wherein applying, for each point in the influence lists:
for points on the source outer cage:
defining a center point as a point of the source outer cage being iterated on;
for points on the source cage that are influenced by the center point:
obtaining the corresponding point on the source outer cage;
computing an offset vector between the source cage at the point influenced by the center point and the source outer cage at the corresponding point;
applying the corresponding rotation and the bulk scale to the offset vector to produce a new vector;
obtaining a weighted deformed point based on the new vector and a corresponding weight from the influence lists; and
adding the weighted deformed point to a corresponding vertex map; and
totaling the weighted deformed points in the vertex map to produce the sum of the weighted deformed points.
